(19) United States
(12) Patent Application Publication
(10) Pub. No.: US 2026/0067771 A1
(43) Pub. Date: Mar. 5, 2026

(54) ENHANCEMENTS RELATED TO HANDOVER FAILURE AND SECONDARY NODE CHANGE FAILURE PREDICTION

(71) Applicant: QUALCOMM Incorporated, San Diego, CA (US)

(72) Inventors: Punyaslok PURKAYASTHA, San Diego, CA (US); Ozcan OZTURK, San Diego, CA (US)

(21) Appl. No.: 18/826,155

(22) Filed: Sep. 5, 2024

(51) Int. Cl. H04W 36/00; H04W 24/02

(52) U.S. Cl. CPC H04W 36/00833; H04W 24/02

(57) ABSTRACT

The apparatus may be a wireless device configured to obtain information related to at least one of a plurality of candidate cells and a source cell, a plurality of synchronization signal blocks (SSBs), or a plurality of reference signals (RSs) to measure in association with a UE mobility, perform, based on the information, a set of measurements of at least one of the plurality of candidate cells and the source cell, the plurality of SSBs, or the plurality of RSs, transmit, for a first network device, a set of predictions related to at least one potential handover operation with at least one candidate cell in the plurality of candidate cells based on the set of measurements performed by the UE and associated with the UE mobility, and perform a handover operation based on the set of predictions.

### TECHNICAL FIELD

The present disclosure relates generally to communication systems, and more particularly, to radio resource management (RRM) for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to obtain information related to at least one of a plurality of candidate cells and a source cell, a plurality of synchronization signal blocks (SSBs), or a plurality of reference signals (RSs) to measure in association with a UE mobility, perform, based on the information, a set of measurements of at least one of the plurality of candidate cells and the source cell, the plurality of SSBs, or the plurality of RSs, transmit, for a first network device, a set of predictions related to at least one potential handover operation with at least one candidate cell in the plurality of candidate cells based on the set of measurements performed by the UE and associated with the UE mobility, and perform a handover operation based on the set of predictions.

In an aspect of the disclosure, a method, a computer-readable medium, and an apparatus are provided. The apparatus may be a wireless device such as a UE configured to obtain information related to at least one of a plurality of candidate primary secondary cells (PSCells) and a source PSCell, a plurality of SSBs, or a plurality of RSs to measure in association with a UE mobility, perform, based on the information, a set of measurements of at least one of the plurality of candidate PSCells and the source PSCell, the plurality of SSBs, or a plurality of RSs, transmit, for a first network device, a set of predictions related to at least one potential PSCell update operation for at least one candidate PSCell in the plurality of candidate PSCells based on the set of measurements performed by the UE and associated with the UE mobility, and perform a PSCell update operation based on the set of predictions.

In an aspect of the disclosure, a method, a computer-readable medium, and an apparatus are provided. The apparatus may be a network device such as a base station or component thereof configured to transmit, for a UE, information related to at least one of a plurality of candidate cells and a source cell, a plurality of SSBs, or a plurality of RSs to measure in association with a UE mobility; obtain, from the UE and based on the information, a set of predictions related to at least one potential handover operation with at least one candidate cell in the plurality of candidate cells, and perform a handover operation based on the prediction.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4 is an example of an AI/ML algorithm for predicting aspects related to mobility in wireless communication and illustrates various aspects model training, model inference, model feedback, and model update.

FIG. 5 is a call flow diagram illustrating a method of wireless communication associated with a HO operation in accordance with some aspects of the disclosure.

FIG. 6 is a call flow diagram illustrating a method of wireless communication associated with a PSCell addition and/or change operation in accordance with some aspects of the disclosure.

FIG. 7 is a flowchart of a method of wireless communication.

FIG. 8 is a flowchart of a method of wireless communication.

FIG. 9A is a flowchart of a method of performing a handover operation based on the set of predictions of FIG. 8 in accordance with some aspects of the disclosure.

FIG. 9B is a flowchart of a method of performing a handover operation based on the set of predictions of FIG. 8 in accordance with some aspects of the disclosure.

FIG. 10 is a flowchart of a method of performing a handover operation based on the set of predictions of FIG. 8 in accordance with some aspects of the disclosure.

FIG. 11 is a flowchart of a method of performing a handover operation based on the set of predictions of FIG. 8 in accordance with some aspects of the disclosure.

FIG. 12 is a flowchart of a method of wireless communication.

FIG. 13 is a flowchart of a method of wireless communication.

FIG. 14A is a flowchart of a method of performing a PSCell update operation based on the set of predictions of FIG. 13 in accordance with some aspects of the disclosure.

FIG. 14B is a flowchart of a method of performing a PSCell update operation based on the set of predictions of FIG. 13 in accordance with some aspects of the disclosure.

FIG. 15 is a flowchart of a method of performing a PSCell update operation based on the set of predictions of FIG. 13 in accordance with some aspects of the disclosure.

FIG. 16 is a flowchart of a method of performing a PSCell update operation based on the set of predictions of FIG. 13 in accordance with some aspects of the disclosure.

FIG. 17 is a flowchart of a method of wireless communication.

FIG. 18 is a diagram illustrating an example of a hardware implementation for an example apparatus and/or network entity.

FIG. 19 is a diagram illustrating an example of a hardware implementation for an example network entity.

FIG. 20 is a diagram illustrating an example of a hardware implementation for an example network entity.

### DETAILED DESCRIPTION

In some aspects of wireless communication, a wireless device may perform a set of measurements regarding a communication environment in association with RRM. The wireless device, in some aspects, may report the measurements to a network device in association with a handover (HO) operation or a PSCell update operation (e.g., one of a PSCell change or a PSCell addition). The reported measurements, in some aspects, may not provide a complete picture of an expected state of the communication environment.

Various aspects relate generally to a UE, via artificial intelligence/machine learning (AI/ML), predicting a HO success probability (or HO failure rate) for specific target cells. The predicted HO success probability (or HO failure rate) for the specific target cells may be provided to a network (or network device) which can use the prediction for HO command decisions. For example, a UE may generate and provide predictions of the state of the communication environment (e.g., a probability of success and/or failure of a HO to one or more target cells) to improve aspects related to one or more of a HO operation, a PSCell change event, and/or a PSCell addition event. Some aspects more specifically relate to measuring transmissions from a set of candidate cells (which may alternatively be referred to as target cells and/or candidate target cells), generating a set of predictions regarding a success and/or failure rate associated with one or more of a HO failure, a PSCell change, or a PSCell addition for one or more candidate cells based on the measurements, providing one or more of the set of predictions to a network device, and performing at least one of the HO operation, the PSCell change, or the PSCell addition associated with the one or more candidate cells. In some examples, a UE may be configured to obtain information related to at least one of a plurality of candidate cells and a source cell, a plurality of SSBs, or a plurality of RSs to measure in association with a UE mobility, perform, based on the information, a set of measurements of at least one of the plurality of candidate cells and the source cell, the plurality of SSBs, or the plurality of RSs, transmit, for a first network device, a set of predictions related to at least one potential handover operation with at least one candidate cell in the plurality of candidate cells based on the set of measurements performed by the UE and associated with the UE mobility, and perform a handover operation based on the set of predictions. In some examples, a UE may be configured to obtain information related to at least one of a plurality of candidate PSCells and a source PSCell, a plurality of SSBs, or a plurality of RSs to measure in association with a UE mobility, perform, based on the information, a set of measurements of at least one of the plurality of candidate PSCells and the source PSCell, the plurality of SSBs, or a plurality of RSs, transmit, for a first network device, a set of predictions related to at least one potential PSCell update operation for at least one candidate PSCell in the plurality of candidate PSCells based on the set of measurements performed by the UE and associated with the UE mobility, and perform a PSCell update operation based on the set of predictions. In some examples, a network device may be configured to transmit, for a UE, information related to at least one of a plurality of candidate cells and a source cell, a plurality of SSBs, or a plurality of RSs to measure in association with a UE mobility; obtain, from the UE and based on the information, a set of predictions related to at least one potential handover operation with at least one candidate cell in the plurality of candidate cells, and perform a handover operation based on the prediction. In some examples, a network device may be configured to transmit, for a UE, information related to at least one of a plurality of candidate PSCells and a source PSCell, a plurality of SSBs, or a plurality of RSs to measure in association with a UE mobility; obtaining, from the UE and based on the information, a set of predictions related to at least one potential PSCell update operation with at least one candidate PSCell in the plurality of candidate PSCells; and performing a PSCell update operation based on the prediction.

Particular aspects of the subject matter described in this disclosure can be implemented to realize one or more of the following potential advantages. In some examples, by generating a set of predictions regarding a communication environment and providing at least one of the predictions to a network device, the described techniques can be used to improve one or more of a HO operation, a PSCell change, or a PSCell addition.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

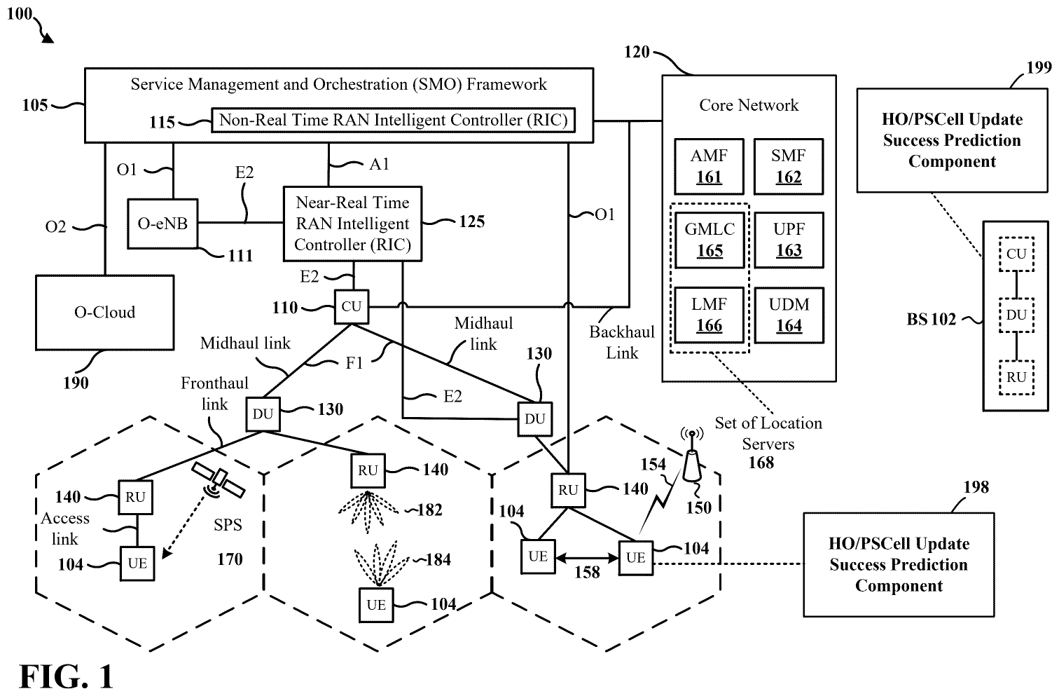

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a HO/PSCell update success prediction component 198 that may be configured to obtain information related to at least one of a plurality of candidate cells and a source cell, a plurality of synchronization signal blocks (SSBs), or a plurality of reference signals (RSs) to measure in association with a UE mobility, perform, based on the information, a set of measurements of at least one of the plurality of candidate cells and the source cell, the plurality of SSBs, or the plurality of RSs, transmit, for a first network device, a set of predictions related to at least one potential handover operation with at least one candidate cell in the plurality of candidate cells based on the set of measurements performed by the UE and associated with the UE mobility, and perform a handover operation based on the set of predictions. The HO/PSCell update success prediction component 198, in some aspects, may be configured to obtain information related to at least one of a plurality of candidate primary secondary cells (PSCells) and a source PSCell, a plurality of SSBs, or a plurality of RSs to measure in association with a UE mobility, perform, based on the information, a set of measurements of at least one of the plurality of candidate PSCells and the source PSCell, the plurality of SSBs, or a plurality of RSs, transmit, for a first network device, a set of predictions related to at least one potential PSCell update operation for at least one candidate PSCell in the plurality of candidate PSCells based on the set of measurements performed by the UE and associated with the UE mobility, and perform a PSCell update operation based on the set of predictions. In certain aspects, the base station 102 may have a HO/PSCell update success prediction component 199 that may be configured to transmit, for a UE, information related to at least one of a plurality of candidate cells and a source cell, a plurality of SSBs, or a plurality of RSs to measure in association with a UE mobility; obtain, from the UE and based on the information, a set of predictions related to at least one potential handover operation with at least one candidate cell in the plurality of candidate cells, and perform a handover operation based on the prediction. In certain aspects, the base station 102 may have a HO/PSCell update success prediction component 199 that may be configured to transmit, for a UE, information related to at least one of a plurality of candidate PSCells and a source PSCell, a plurality of SSBs, or a plurality of RSs to measure in association with a UE mobility; obtaining, from the UE and based on the information, a set of predictions related to at least one potential PSCell update operation with at least one candidate PSCell in the plurality of candidate PSCells; and performing a PSCell update operation based on the prediction. Although the following description may be focused on 5G NR, the concepts described herein may be applicable to other similar areas, such as LTE, LTE-A, CDMA, GSM, and other wireless technologies.

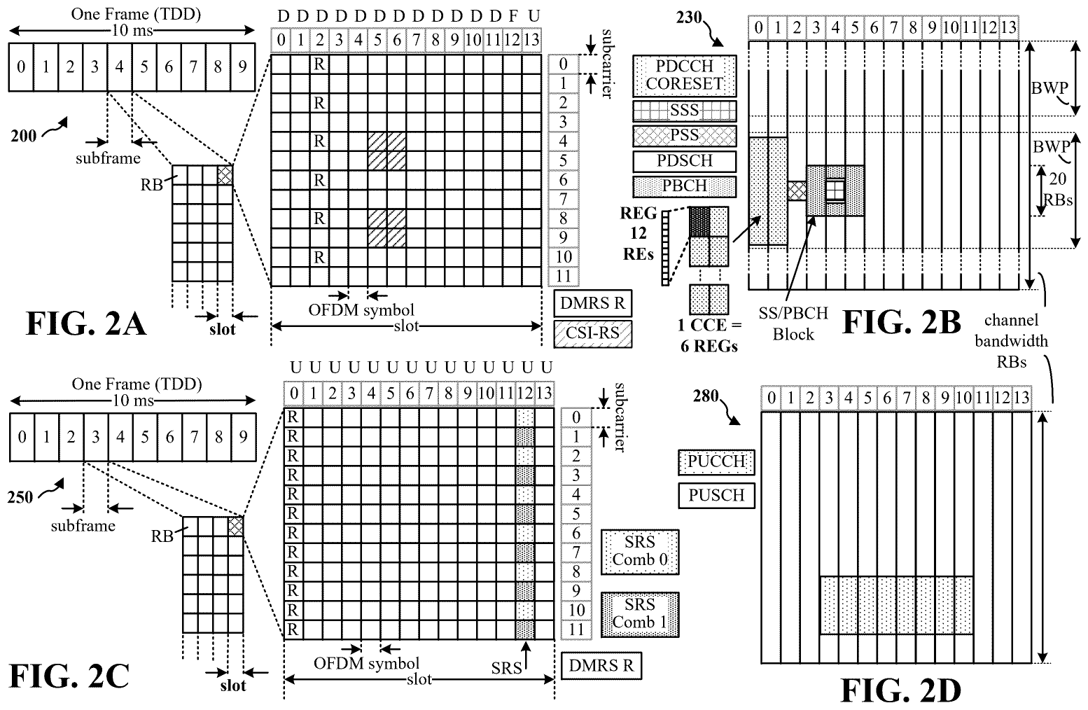

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

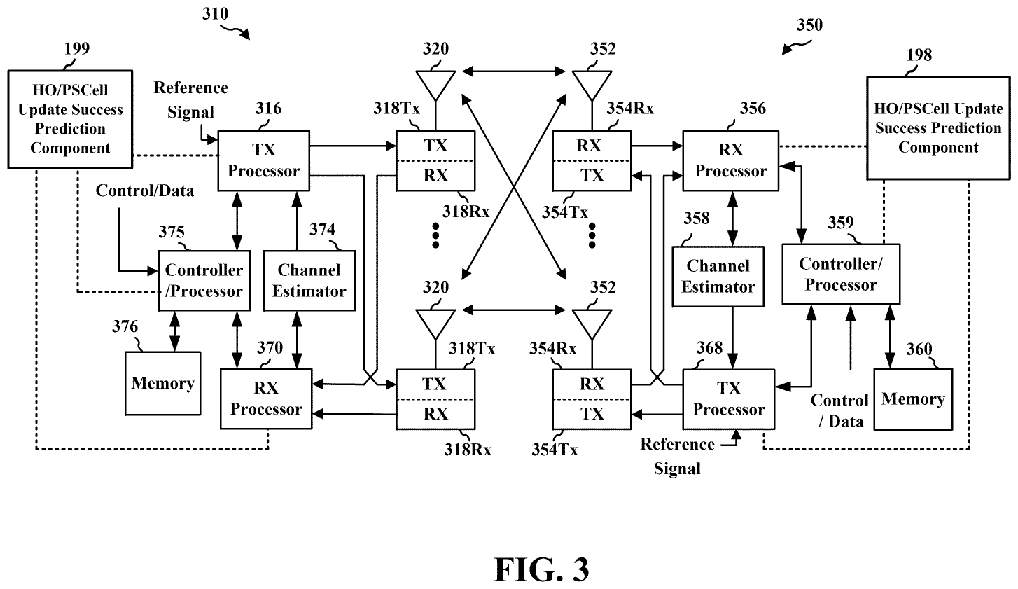

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the HO/PSCell update success prediction component 198 of FIG. 1.

At least one of the TX processor 316, the RX processor 370, and the controller/processor 375 may be configured to perform aspects in connection with the HO/PSCell update success prediction component 199 of FIG. 1.

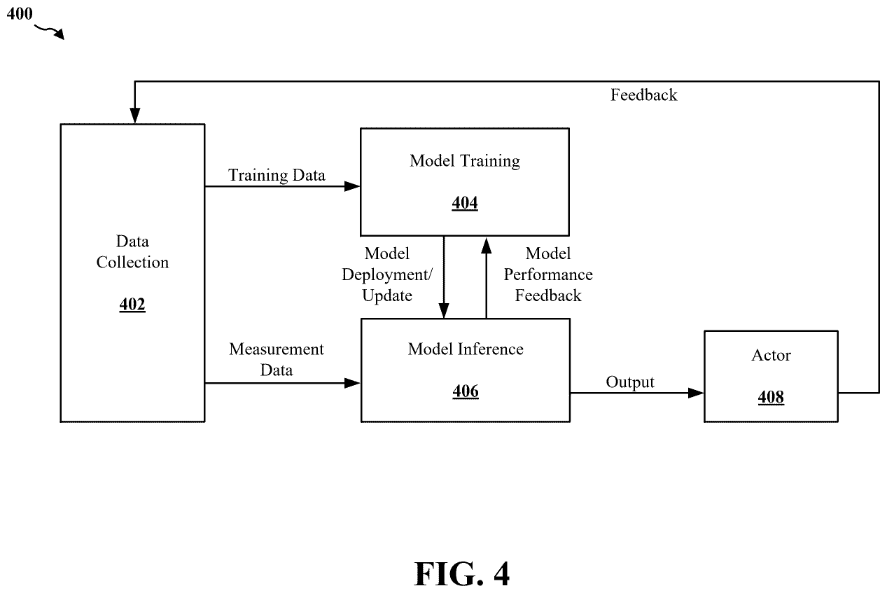

FIG. 4 is an example of an AI/ML algorithm 400 for predicting aspects related to mobility in wireless communication and illustrates various aspects model training, model inference, model feedback, and model update. The AI/ML algorithm 400 may include various aspects including a data collection 402, a model training 404, model inference 406, and an actor 408 that receives and uses output based on the model inference.

The data collection 402 may be a function that provides input data for the model training 404 and the model inference 406. The data collection 402 function may include any form of data preparation, and it may not be specific to the implementation of the AI/ML algorithm (e.g., data pre-processing and cleaning, formatting, and transformation).

The examples of input data may include, but are not limited to, beam and cell measurements of source and candidate cells (e.g., a set of measurements of at least one of a plurality of candidate cells and/or a source cell, a plurality of SSBs, or a plurality of RSs), feedback from the actor 408 (e.g., which may be associated with a UE or network node), output from another AI/ML model. The data collection 402 may include training data, which refers to the data to be sent as the input for the AI/ML model training 404, and inference data, which refers to data input for the AI/ML model inference (e.g., 406).

The model training 404 may be a function that performs the ML model training, validation, and testing, which may generate model performance metrics as part of the model testing procedure. The model training 404 may also include data preparation (e.g., data pre-processing and cleaning, formatting, and transformation) based on the training data delivered or received from the data collection 402 function. The model training 404 component may deploy or update a trained, validated, and tested AI/ML model to the model inference 406 component, and receive a model performance feedback from the model inference 406 component. As described above, there may be various functionalities to be performed by an AI/ML model for wireless communication.

The model inference 406 may be a function that provides the AI/ML model inference output (e.g., predictions or decisions). The model inference 406 may also perform data preparation (e.g., data pre-processing and cleaning, formatting, and transformation) based on the inference data delivered from the data collection 402 function. The output of the model inference 406 may include the inference output of the AI/ML model produced by the model inference 406. The details of the inference output may be use case specific. As an example, the output may include one or more of beam measurement predictions for the source cell and the candidate cells, cell measurement predictions for the source cell and the candidate cells, predictions for measurement events related to mobility (A3, A5), predictions for occurrence of radio link failure (RLF) on the source cell, predictions for occurrence of handover failure (e.g., failure to complete access, e.g., RACH, on the candidate cells). The prediction may be for the transmitter or the receiver and may be for the network or the UE. In some aspects, the actor may be a component of the base station or of a core network. In other aspects, the actor may be a UE in communication with a wireless network.

The model performance feedback may refer to information derived from the model inference 406 function that may be suitable for the improvement of the AI/ML model trained in the model training 404. The feedback from the actor 408 or other network entities (via the data collection 402 function) may be implemented for the model inference 406 to create the model performance feedback.

The actor 408 may be a function that receives the output from the model inference 406 and triggers or performs corresponding actions. The actor may trigger actions directed to network entities including the other network entities or itself. The actor 408 may also provide a feedback information that the model training 404 or the model inference 406 to derive training or inference data or performance feedback. The feedback may be transmitted back to the data collection 402.

A network or UE may use machine-learning algorithms, deep-learning algorithms, neural networks, reinforcement learning, regression, boosting, or advanced signal processing methods for aspects of wireless communication including predicting aspects related to mobility in wireless communication, e.g., beam measurement predictions for the source cell and the candidate cells, cell measurement predictions for the source cell and the candidate cells, predictions for measurement events related to mobility (A3, A5), predictions for occurrence of RLF on the source cell, predictions for occurrence of handover failure (e.g., failure to complete access [or RACH], on the candidate cells), among other examples.

In some aspects described herein, the network may train one or more neural networks to learn the dependence of measured qualities on individual parameters. Among others, examples of machine learning models or neural networks that may be included in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by the concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution A×B operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., any feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processor for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from input at a first layer through the multiple layers of the neural network to output at the last layer of the neural network and may traverse layers multiple times.

In some aspects of wireless communication, a wireless device may perform a set of measurements regarding a communication environment in association with RRM. The wireless device, in some aspects, may report the measurements to a network device in association with a HO operation or a PSCell update operation (e.g., one of a PSCell change or a PSCell addition). The reported measurements, in some aspects, may not provide a complete picture of an expected state of the communication environment.

Various aspects relate generally to a UE, via AI/ML, predicting a HO success probability (or HO failure rate) for specific target cells. The predicted HO success probability (or HO failure rate) for the specific target cells may be provided to a network (or network device) which can use the prediction for HO command decisions. For example, a UE may generate and provide predictions of the state of the communication environment (a probability of success and/or failure of a HO to one or more target cells) to improve aspects related to one or more of a HO operation, a PSCell change event, and/or a PSCell addition event. Some aspects more specifically relate to measuring transmissions from a set of candidate cells (which may alternatively be referred to as target cells and/or candidate target cells), generating a set of predictions regarding a success and/or failure rate associated with one or more of a HO failure, a PSCell change, or a PSCell addition for one or more candidate cells based on the measurements, providing one or more of the set of predictions to a network device, and performing at least one of the HO operation, the PSCell change, or the PSCell addition associated with the one or more candidate cells. In some examples, a UE may be configured to obtain information related to at least one of a plurality of candidate cells and a source cell, a plurality of SSBs, or a plurality of RSs to measure in association with a UE mobility, perform, based on the information, a set of measurements of at least one of the plurality of candidate cells and the source cell, the plurality of SSBs, or the plurality of RSs, transmit, for a first network device, a set of predictions related to at least one potential handover operation with at least one candidate cell in the plurality of candidate cells based on the set of measurements performed by the UE and associated with the UE mobility, and perform a handover operation based on the set of predictions. In some examples, a UE may be configured to obtain information related to at least one of a plurality of candidate PSCells and a source PSCell, a plurality of SSBs, or a plurality of RSs to measure in association with a UE mobility, perform, based on the information, a set of measurements of at least one of the plurality of candidate PSCells and the source PSCell, the plurality of SSBs, or a plurality of RSs, transmit, for a first network device, a set of predictions related to at least one potential PSCell update operation for at least one candidate PSCell in the plurality of candidate PSCells based on the set of measurements performed by the UE and associated with the UE mobility, and perform a PSCell update operation based on the set of predictions. In some examples, a network device may be configured to transmit, for a UE, information related to at least one of a plurality of candidate cells, a plurality of SSBs, or a plurality of RSs to measure in association with a UE mobility; obtain, from the UE and based on the information, a set of predictions related to at least one potential handover operation with at least one candidate cell in the plurality of candidate cells, and perform a handover operation based on the prediction.

In some aspects, a HO procedure, a PSCell addition, or a PSCell change may be related to a mobility event such as (1) the selection of a new cell for performing a cell change to (or to which to perform a cell change), (2) a quality of a source cell degrading more than a threshold, (3) a quality of a neighbor cell improving more than a threshold, (4) a change in the mobility state, (5) entering and/or exiting the coverage of a specific cell, beam, zone, etc., or (6) any other condition associated with UE mobility (See, e.g., Table 2).

TABLE 2
Measurement Events

| Event Type | Purpose of events |
|---|---|
| Event A1 | Serving becomes better than threshold |
| Event A2 | Serving becomes worse than threshold |
| Event A3 | Neighbor becomes offset better than a |
| | special cell SpCell) |
| Event A4 | Neighbor becomes better than threshold |
| Event A5 | SpCell becomes worse than threshold1 and |
| | neighbor becomes better than threshold2 |
| Event A6 | Neighbor becomes offset better than SCell |
| Event B1 | Inter RAT neighbor becomes better than threshold |
| Event B2 | PCell becomes worse than threshold1 and inter |
| | RAT neighbor becomes better than threshold2 |

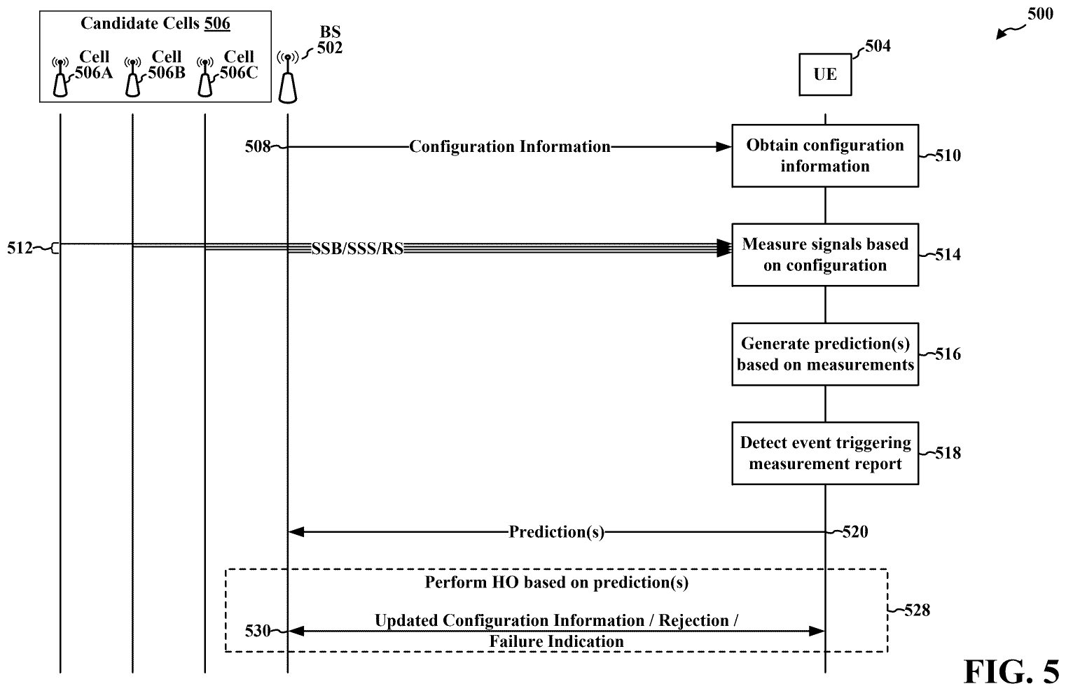

FIG. 5 is a call flow diagram 500 illustrating a method of wireless communication associated with a HO operation in accordance with some aspects of the disclosure. The method is illustrated in relation to a base station 502 (e.g., as an example of a network device or network node that may include one or more components of a disaggregated base station) in communication with a UE 504 (e.g., as an example of a wireless device). The functions ascribed to the base station 502, in some aspects, may be performed by one or more components of a network entity, a network node, or a network device (a single network entity/node/device or a disaggregated network entity/node/device as described above in relation to FIG. 1). Similarly, the functions ascribed to the UE 504, in some aspects, may be performed by one or more components of a wireless device supporting communication with a network entity/node/device. Accordingly, references to “transmitting” in the description below may be understood to refer to a first component of the base station 502 (or the UE 504) outputting (or providing) an indication of the content of the transmission to be transmitted by a different component of the base station 502 (or the UE 504). Similarly, references to “receiving” in the description below may be understood to refer to a first component of the base station 502 (or the UE 504) receiving a transmitted signal and outputting (or providing) the received signal (or information based on the received signal) to a different component of the base station 502 (or the UE 504).

The UE 504, in some aspects, may employ an AI/ML model associated with mobility between a source cell (e.g., the base station 502) and a candidate cell in a set of candidate cells (e.g., one of candidate cell 506A, candidate cell 506B, or candidate cell 506C in the set of candidate cells 506). The base station 502 may transmit, and a UE 504 may receive, configuration information 508 as part of obtaining configuration information at 510. The configuration information 508, in some aspects, may include one or more of a list of one or more candidate cells (and the associated candidate frequencies) for UE mobility, a list of one or more beams (e.g., SSBs or SSSs within the SSB) to measure for the source cell (e.g., the base station 502) as well as for the candidate cells, and/or one or more RSs to measure in association with a UE mobility.

Based on the configuration information 508 and a set of transmissions 512 from the base station 502 and the set of candidate cells 506, the UE 504 may perform, at 514, beam measurements on, or related to, the base station 502 and the candidate cells. The set of transmissions 512, in some aspects, may include SSB, SSSs, or one or more RSs transmitted by the base station and/or the candidate cells in the set of candidate cells. The beam measurements, in some aspects, may be used to determine a set of cell measurements for the base station 502 and one or more of the candidate cells in the set of candidate cells 506. In some aspects, the beam measurements and/or the cell measurements may be referred to as RRM measurements.

In some aspects, the UE 504 may, at 516, generate one or more predictions based on the beam measurements (e.g., the measurements of the set of transmissions 512) using an AI/ML model (e.g., a machine-trained model). The inputs to the AI/ML model for mobility, in some aspects, may be the beam and/or cell measurements of the base station 502 and the set of candidate cells 506 (e.g., a source cell and one or more candidate cells). In some aspects, the output of the AI/ML model may include one or more of a set of beam measurement predictions for the base station 502 and the candidate cells (e.g., each candidate cell 506A-506C) in the set of candidate cells 506, cell measurement predictions for the base station 502 and the candidate cells (e.g., each candidate cell 506A-506C) in the set of candidate cells 506, predictions for measurement events related to mobility (e.g., events in Table 2), predictions for occurrence of radio link failure (RLF) on the base station 502, one or more predictions for an occurrence of a handover failure for the candidate cells (e.g., a predicted success and/or failure probability associated with a handover operation to, or associated with, each of the set of candidate cells). In some aspects, a handover failure may include a failure to complete an initial access procedure and/or operation associated with a candidate cell (e.g., a random access procedure for performing a handover to a candidate cell associated with the handover operation).

Some aspects of handover failure prediction at a UE may include enhancements to enable the UE to indicate predicted handover failures to the network and UE actions to avoid handover failure by performing handover to another suitable cell configured by the network as discussed below. In some aspects, based on the predictions, the UE 504 may, at 518, detect an event triggering a measurement report. Based on detecting the triggering event at 518, the UE 504 may transmit a message 520 including the set of predictions generated at 516. In some aspects, the message 520 may also include the beam and/or cell measurements made at 514. For example, in some aspects, the message 520 may be a measurement report message triggered due to occurrence of a handover related event at the UE 504, e.g., A3 or A5 from Table 2, and the message 520 may include an indication of a predicted handover success rate to a candidate cell. The UE 504, in the message 520, may provide indications of the predicted handover success rates to multiple candidate cells. The handover success rate for a candidate cell, in some aspects, may be defined to be, and/or related to, the probability of successful handover to the candidate cell and may be derived and/or generated at the UE using the AI/ML model and based on the RRM measurement predictions, e.g., the predictions of beam and/or cell measurements of the candidate cell. In some aspects, the message 520 may include beam and cell measurements and/or beam and cell measurement predictions related to, of, or for, the base station 502 and the one or more candidate cells (e.g., the source cell and the candidate cells).

At 528, the UE 504 and the base station 502 may perform a handover operation based on the prediction included in the message 520. Performing the handover operation at 528, in some aspects, may be associated with one or more communications 530. In some aspects, performing the handover operation at 528 may include, upon receiving the message 520 and based on the indicated handover success rates, the base station 502 (or the network) performing a cancellation of handovers to some of the prepared candidate cells and providing to the UE 504 a revised indication of one or more candidate cells for handover (e.g., in an RRC configuration message of the one or more communications 530 associated with a HO operation, a conditional HO (CHO), an L1/L2 triggered mobility (LTM), or a conditional LTM). In some aspects, based upon the prediction(s) of a handover failure to one or more candidate cells, e.g., if the handover failure probability is greater than a threshold probability, the UE 504 can “reject” a handover command, i.e., not perform handover to the candidate cell. In some aspects, the threshold probability may be configured by the network (e.g., indicated to the UE from the network). If a handover command is rejected, the UE 504 may, in some aspects, transmit an indication (e.g., a message or a report included in the one or more communications 530) to the base station 502 that the UE 504 will not perform the handover and/or a cause value (e.g., a value indicating a reason for rejecting the handover with an indicated cell), and may provide related measurement reports and/or measurement predictions. If configured with CHO, LTM, or conditional LTM candidate cells, the UE 504 may perform a handover to another candidate cell (e.g., a handover operation associated with the other candidate cell). For example, if a related CHO, LTM, or conditional LTM execution condition is satisfied for at least one candidate cell (or if an associated measurement prediction indicates that the execution condition is predicted to be satisfied with a probability that is greater than a threshold probability) the UE 504 may perform a handover operation with a candidate cell of the at least one candidate cell.

In some aspects, the predictions generated at 516 may include a prediction that a timer associated with the handover operation for a particular candidate cell (e.g., a T304 timer associated with a RRC reconfiguration message such as RRCReconfiguration) is likely to expire (e.g., is predicted to expire with a probability that is above a threshold probability). Based on the prediction of the timer expiration, performing the handover operation based on the predictions generated at 516 may include stopping the timer (e.g., the T304 time) and initiating RRC re-establishment or performing CHO recovery on a configured CHO candidate cell based on measurements (or predicted measurements) associated with the configured CHO candidate cell.

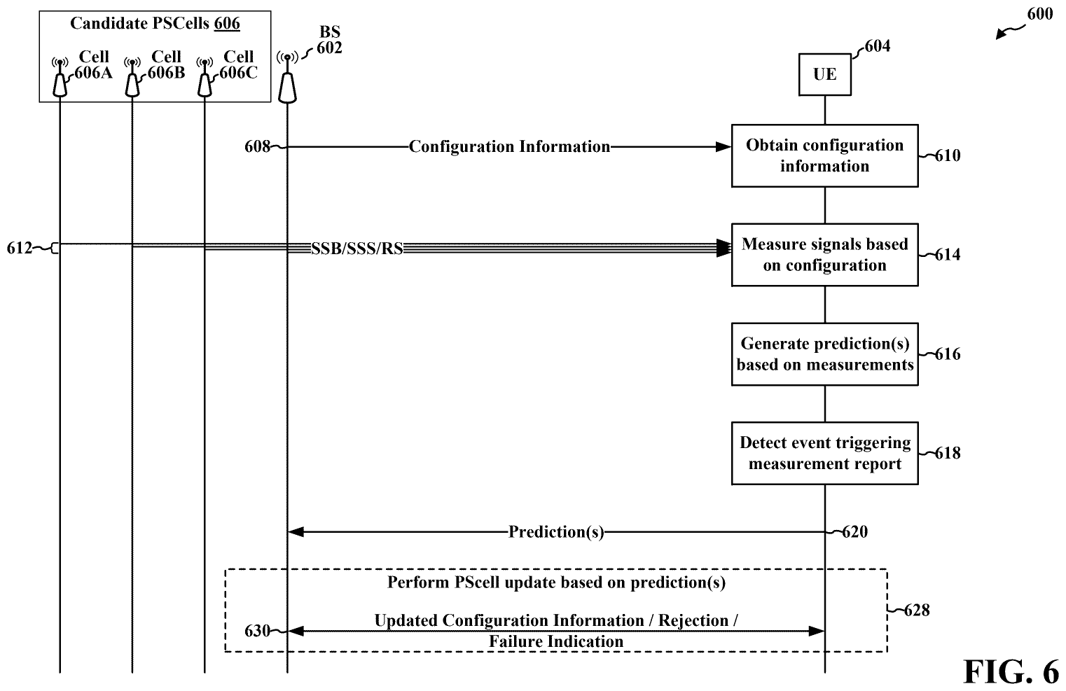

FIG. 6 is a call flow diagram 600 illustrating a method of wireless communication associated with a PSCell addition and/or change operation in accordance with some aspects of the disclosure. The method is illustrated in relation to a base station 602 (e.g., as an example of a network device or network node that may include one or more components of a disaggregated base station) in communication with a UE 604 (e.g., as an example of a wireless device). The functions ascribed to the base station 602, in some aspects, may be performed by one or more components of a network entity, a network node, or a network device (a single network entity/node/device or a disaggregated network entity/node/device as described above in relation to FIG. 1). Similarly, the functions ascribed to the UE 604, in some aspects, may be performed by one or more components of a wireless device supporting communication with a network entity/node/device. Accordingly, references to “transmitting” in the description below may be understood to refer to a first component of the base station 602 (or the UE 604) outputting (or providing) an indication of the content of the transmission to be transmitted by a different component of the base station 602 (or the UE 604). Similarly, references to “receiving” in the description below may be understood to refer to a first component of the base station 602 (or the UE 604) receiving a transmitted signal and outputting (or providing) the received signal (or information based on the received signal) to a different component of the base station 602 (or the UE 604).

The UE 604, in some aspects, may employ an AI/ML model associated with a PSCell change and/or a PSCell addition associated with one or more candidate PSCells in a set of candidate PSCells (e.g., one or more of a candidate cell 606A, a candidate PSCell 606B, or a candidate PSCell 606C in the set of candidate PSCells 606). In some aspects, a particular candidate cell (e.g., the candidate PSCell 606A) in the set of candidate PSCells 606 may be selected and/or configured as a PSCell. The set of candidate PSCells 606, in some aspects, may be associated with a PSCell update operation (e.g., one or more of a PSCell change and/or a PSCell addition). The base station 602 may transmit, and a UE 604 may receive, configuration information 608 as part of obtaining configuration information at 610. The configuration information 608, in some aspects, may include one or more of: a list of one or more candidate cells and/or candidate PSCells, (and the associated candidate frequencies) for UE mobility associated with a PSCell, a list of one or more beams (e.g., SSBs) to measure for the source cell (e.g., the base station 602) as well as for the candidate cells (e.g., candidate PSCells), and/or one or more RSs to measure in association with a UE mobility (e.g., associated with a PSCell change and/or PSCell addition).

Based on the configuration information 608 and a set of transmissions 612 from the base station 602 and the set of candidate PSCells 606, the UE 604 may perform, at 614 beam measurements on, or related to, the base station 602 and the candidate PSCells. The set of transmissions 612, in some aspects, may include SSB, SSSs, or one or more RSs transmitted by the base station and/or the candidate cells in the set of candidate PSCells. The beam measurements, in some aspects, may be used to determine a set of cell measurements for the base station 602 and one or more of the candidate PSCells in the set of candidate PSCells 606. In some aspects, the beam measurements and/or the cell measurements may be referred to as RRM measurements.

In some aspects, the UE 604 may, at 616 generate one or more predictions based on the beam measurements (e.g., the measurements of the set of transmissions 612) using an AI/ML model (e.g., a machine-trained model). The inputs to the AI/ML model for mobility, in some aspects, may be the beam and/or cell measurements of the base station 602 and the set of candidate PSCells 606 (e.g., a source cell and one or more candidate cells). In some aspects, the output of the AI/ML model may include one or more of a set of beam measurement predictions for the base station 602 and the candidate cells (e.g., each candidate PSCells 606A-606C) in the set of candidate PSCells 606, cell measurement predictions for the base station 602 and the candidate PSCells (e.g., each candidate PSCells 606A-606C) in the set of candidate PSCells 606, predictions for measurement events related to mobility (e.g., events in Table 2), predictions for occurrence of RLF on the base station 602 and/or a currently selected PSCell, one or more predictions for an occurrence of a PSCell update operation failure for the candidate PSCells (e.g., a predicted success and/or failure probability associated with a PSCell addition and/or change operation to, or associated with, each of the set of candidate cells). In some aspects, a PSCell update operation failure may include a failure to complete an initial access procedure and/or operation associated with a candidate PSCells (e.g., a random access procedure for performing a cell change to a candidate cell associated with the PSCell addition and/or change operation).

Some aspects of PSCell update failure prediction at a UE may include enhancements to enable the UE to indicate the PSCell update failure prediction(s) to the network and UE actions to avoid handover failure by performing the PSCell addition and/or change operation to another suitable cell configured by the network as discussed below. In some aspects, based on the predictions, the UE 604 may, at 618, detect an event triggering a measurement report associated with a PSCell addition and/or change operation. Based on detecting the triggering event at 618, the UE 604 may transmit a message 620 including the set of predictions generated at 616. In some aspects, the message 620 may also include the beam and/or cell measurements made at 614. For example, in some aspects, the message 620 may be a measurement report message indicating the occurrence of a PSCell change and/or a PSCell addition event at the UE, e.g., A3, A5, A4, or B1 from Table 2, and the message 620 may include an indication of a predicted PSCell change and/or PSCell addition success rate to a candidate cell (e.g., a PSCell). The UE 604, in the message 620, may provide indications of predicted PSCell change and/or PSCell addition success rates to, or associated with, multiple candidate cells (candidate PSCells) in the message. The PSCell change and/or PSCell addition success rate for a candidate cell, in some aspects, may be defined to be, and/or related to, the probability of a successful PSCell change and/or PSCell addition to, or associated with, the candidate cell and may be derived and/or generated at the UE using the AI/ML model and based on the RRM measurement predictions, e.g., the predictions of beam and/or cell measurements of the candidate cell. In some aspects, the message 620 may include beam and cell measurements and/or beam and cell measurement predictions related to, of, or for, the base station 602 and the one or more candidate cells (e.g., the source cell and the candidate cells).

At 628, the UE 604 and the base station 602 may perform a PSCell addition and/or PSCell change operation based on the prediction included in the message 620. Performing the PSCell addition and/or PSCell change operation at 628, in some aspects, may be associated with one or more communications 630. In some aspects, performing the PSCell addition and/or PSCell change operation at 628 may include, upon receiving the message 620 and based on the indicated PSCell change and/or PSCell addition success rates, the base station 602 (or the network) performing a cancellation of a PSCell addition and/or PSCell change to some of the prepared candidate cells and providing to the UE 604 a revised indication of one or more candidate cells for PSCell addition and/or PSCell change (e.g., in an RRC configuration message associated with a PSCell addition and/or PSCell change, a conditional PSCell addition (CPA), a conditional PSCell change (CPC), LTM, or conditional LTM). In some aspects, based upon its predictions of a PSCell addition and/or PSCell change failure to, or associated with, one or more candidate cells, e.g., if the PSCell addition and/or PSCell change failure probability is greater than a threshold probability, the UE 604 can “reject” a PSCell addition and/or PSCell change command, i.e., not perform the PSCell addition and/or PSCell change to, or associated with, the candidate cell. If a PSCell addition and/or PSCell change command is rejected, the UE 604 may, in some aspects, transmit an indication (e.g., a message or a report included in the one or more communications 630) to the base station 602 (e.g., a primary cell or PCell) that the UE 604 will not perform the PSCell addition and/or PSCell change operation and/or a cause value (e.g., a value indicating a reason for rejecting the PSCell addition and/or PSCell change operation with an indicated cell), and may provide related measurement reports. If configured with CPA, CPC, LTM, or conditional LTM candidate cells, the UE 604 may perform a PSCell addition and/or PSCell change operation to another candidate cell (e.g., a PSCell addition and/or PSCell change operation associated with the other candidate cell). For example, if a related CPA, CPC, LTM, or conditional LTM execution condition is satisfied for at least one candidate cell (or if an associated measurement prediction indicates that the execution condition is predicted to be satisfied with a probability that is greater than a threshold probability) the UE 604 may perform a PSCell addition and/or PSCell change operation with a candidate cell of the at least one candidate cell.

In some aspects, the predictions generated at 616 may include a prediction that a timer associated with the PSCell addition and/or PSCell change operation for a particular candidate cell (e.g., a T304 timer associated with a RRC reconfiguration message such as RRCReconfiguration) is likely to expire (e.g., is predicted to expire with a probability that is above a threshold probability). Based on the prediction of the timer expiration, performing the PSCell addition and/or PSCell change operation based on the predictions generated at 616 may include stopping the timer (e.g., the T304 time) and initiating a SCG failure information procedure, initiating RRC re-establishment, or performing CPA and/or CPC recovery on a configured CPA and/or CPC candidate cell based on measurements (or predicted measurements) associated with the configured CPA and/or CPC candidate cell.

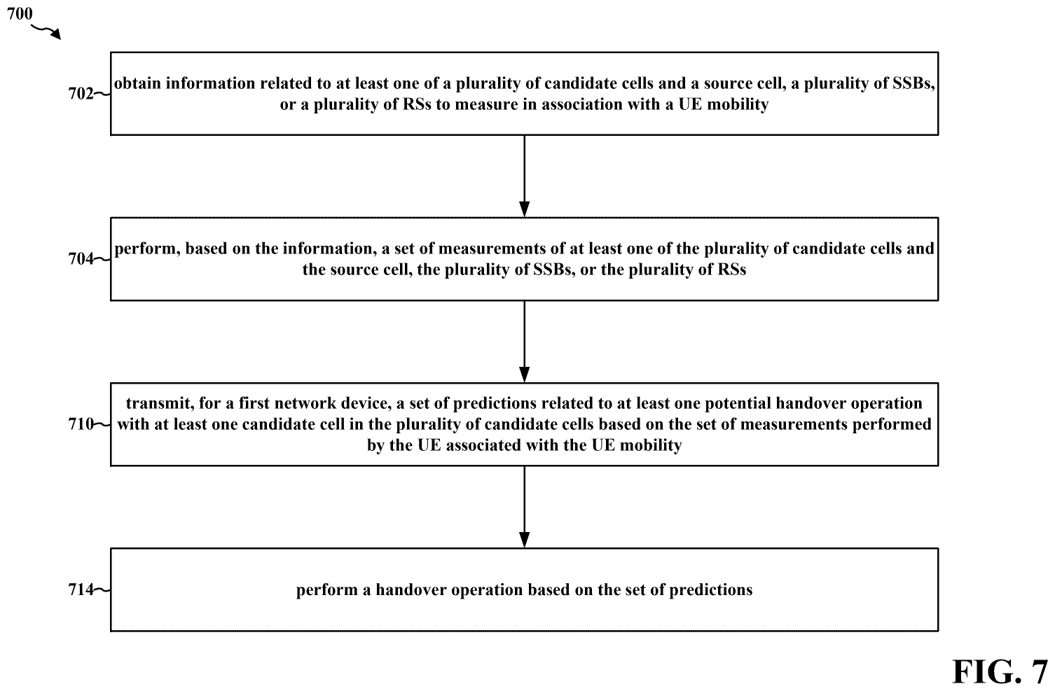

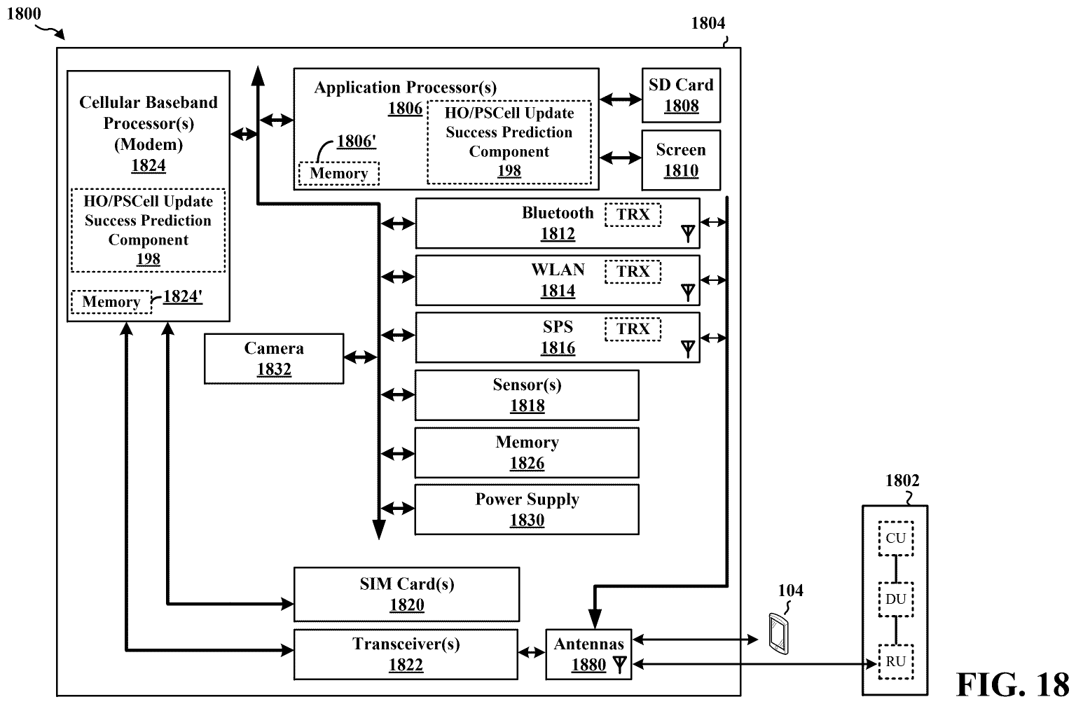

FIG. 7 is a flowchart 700 of a method of wireless communication. The method may be performed by a UE (e.g., the UE 104, 504; the apparatus 1804). At 702, the UE may obtain (or receive) information related to at least one of a plurality of candidate cells and a source cell, a plurality of SSBs, or a plurality of RSs to measure in association with a UE mobility. For example, 702 may be performed by application processor(s) 1806, cellular baseband processor(s) 1824, transceiver(s) 1822, antenna(s) 1880, and/or HO/PSCell update success prediction component 198 of FIG. 18. In some aspects, the information may be related to a plurality of SSSs to measure in association with the UE mobility. For example, referring to FIG. 5, the UE 504 may receive, configuration information 508 as part of obtaining configuration information at 510.

At 704, the UE may measure (or perform, based on the information, a set of measurements of) at least one of the plurality of candidate cells and the source cell, the plurality of SSBs, or the plurality of RSs. For example, 704 may be performed by application processor(s) 1806, cellular baseband processor(s) 1824, transceiver(s) 1822, antenna(s) 1880, and/or HO/PSCell update success prediction component 198 of FIG. 18. In some aspects, to obtain the set of measurements, the UE may measure one or more of the plurality of candidate cells and the source cell, the plurality of SSBs, or the plurality of RSs. To obtain the set of measurements, in some aspects, the UE may measure the plurality of SSSs. For example, referring to FIG. 5, the UE 504 may perform, at 514 beam measurements for, on, or related to, a set of transmissions 512 from the base station 502 and the set of candidate cells 506.

In some aspects, the UE may generate, using an AI/ML model (or MT network), a set of predictions based on the set of measurements. In some aspects, the set of measurements may be provided as inputs to the AI/ML model (or MT network), and the output of the AI/ML model (or MT network) may be the set of predictions. The set of predictions, in some aspects, may include a first prediction of a probability of a failure of a particular handover operation associated with a particular candidate cell in the plurality of candidate cells. The set of predictions, in some aspects, may include at least one of: a set of beam measurement predictions for the source cell and the plurality of candidate cells, a set of cell measurement predictions for the source cell and the plurality of candidate cells, one or more predictions of measurement events related to mobility, and one or more additional predictions of a RLF associated with the source cell. For example, referring to FIG. 5, the UE 504 may generate, at 516, one or more predictions based on performing the beam measurements at 514 (e.g., the measurements of the set of transmissions 512) using an AI/ML model (e.g., a machine-trained model).

The UE, in some aspects, may detect, based on the set of measurements, a handover related event. Detecting the handover related event, in some aspects, may be based on at least one prediction in the set of predictions generated at 706. In some aspects, the handover related may be, e.g., one of A3 or A5 or other event included in Table 2 above. For example, referring to FIG. 5, the UE 504 may, at 518, detect an event triggering a measurement report based on performing the beam measurements at 514 and, in some aspects, generating the one or more predictions at 516.

At 710, the UE may transmit, for a first network device, a set of predictions related to at least one potential handover operation with at least one candidate cell in the plurality of candidate cells based on the set of measurements performed by the UE and associated with the UE mobility. In some aspects, the UE may, transmit, for the first network device, a subset of the set of measurements. For example, 710 may be performed by application processor(s) 1806, cellular baseband processor(s) 1824, transceiver(s) 1822, antenna(s) 1880, and/or HO/PSCell update success prediction component 198 of FIG. 18. Transmitting the set of predictions, in some aspects, may include transmitting the set of predictions based on the detected handover related event. The subset of the set of measurement (e.g., all or some of the measurements in the set of measurements), in some aspects, may include measurements associated with the detected handover related event or the transmitted set of predictions. The UE, in some aspects, may transmit the set of predictions and/or the subset of the set of measurements in a measurement report. For example, referring to FIG. 5, the UE 504 may transmit a message 520 including the set of predictions generated at 516 and, in some aspects, including a subset of the measurements based on performing the beam measurements at 514.

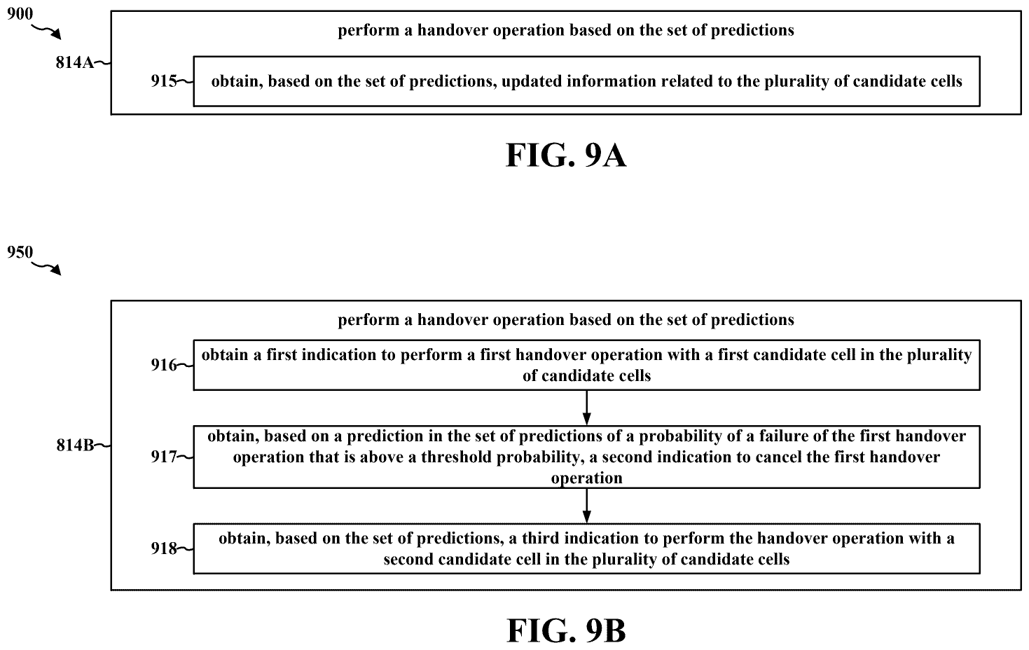

At 714, the UE may perform a handover operation based on the set of predictions. For example, 714 may be performed by application processor(s) 1806, cellular baseband processor(s) 1824, transceiver(s) 1822, antenna(s) 1880, and/or HO/PSCell update success prediction component 198 of FIG. 18. For example, referring to FIG. 5, the UE 504 may perform a handover operation at 528. Aspects of performing the handover under different conditions are described in relation to FIGS. 9A, 9B, 10, and 11.

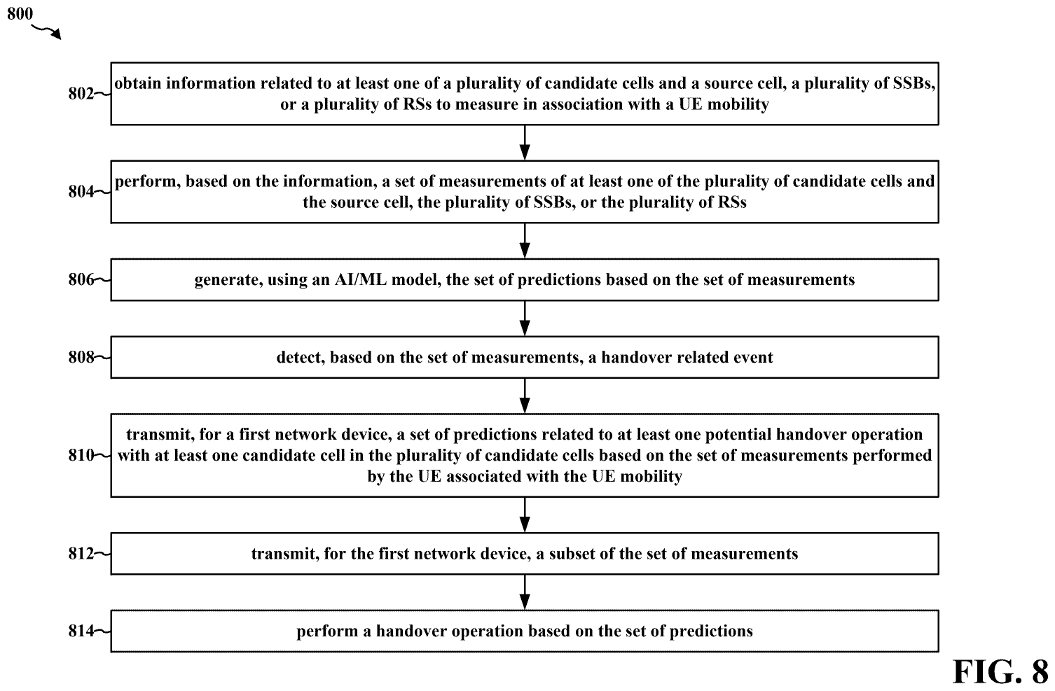

FIG. 8 is a flowchart 800 of a method of wireless communication. The method may be performed by a UE (e.g., the UE 104, 504; the apparatus 1804). At 802, the UE may obtain (or receive) information related to at least one of a plurality of candidate cells and a source cell, a plurality of SSBs, or a plurality of RSs to measure in association with a UE mobility. For example, 802 may be performed by application processor(s) 1806, cellular baseband processor(s) 1824, transceiver(s) 1822, antenna(s) 1880, and/or HO/PSCell update success prediction component 198 of FIG. 18. In some aspects, the information may be related to a plurality of SSSs to measure in association with the UE mobility. For example, referring to FIG. 5, the UE 504 may receive, configuration information 508 as part of obtaining configuration information at 510.

At 804, the UE may measure (or perform, based on the information, a set of measurements of) at least one of the plurality of candidate cells and the source cell, the plurality of SSBs, or the plurality of RSs. For example, 804 may be performed by application processor(s) 1806, cellular baseband processor(s) 1824, transceiver(s) 1822, antenna(s) 1880, and/or HO/PSCell update success prediction component 198 of FIG. 18. In some aspects, to obtain the set of measurements, the UE may measure one or more of the plurality of candidate cells and the source cell, the plurality of SSBs, or the plurality of RSs. To obtain the set of measurements, in some aspects, the UE may measure the plurality of SSSs. For example, referring to FIG. 5, the UE 504 may perform, at 514 beam measurements for, on, or related to, a set of transmissions 512 from the base station 502 and the set of candidate cells 506.

At 806, the UE may generate, using an AI/ML model (or MT network), a set of predictions based on the set of measurements. For example, 806 may be performed by application processor(s) 1806, cellular baseband processor(s) 1824, transceiver(s) 1822, antenna(s) 1880, and/or HO/PSCell update success prediction component 198 of FIG. 18. In some aspects, the set of measurements may be provided as inputs to the AI/ML model (or MT network), and the output of the AI/ML model (or MT network) may be the set of predictions. The set of predictions, in some aspects, may include a first prediction of a probability of a failure of a particular handover operation associated with a particular candidate cell in the plurality of candidate cells. The set of predictions, in some aspects, may include at least one of: a set of beam measurement predictions for the source cell and the plurality of candidate cells, a set of cell measurement predictions for the source cell and the plurality of candidate cells, one or more predictions of measurement events related to mobility, and one or more additional predictions of a RLF associated with the source cell. For example, referring to FIG. 5, the UE 504 may generate, at 516, one or more predictions based on performing the beam measurements at 514 (e.g., the measurements of the set of transmissions 512) using an AI/ML model (e.g., a machine-trained model).

At 808, the UE may detect, based on the set of measurements, a handover related event. For example, 808 may be performed by application processor(s) 1806, cellular baseband processor(s) 1824, transceiver(s) 1822, antenna(s) 1880, and/or HO/PSCell update success prediction component 198 of FIG. 18. Detecting the handover related event, in some aspects, may be based on at least one prediction in the set of predictions generated at 806. In some aspects, the handover related event may be, e.g., one of A3 or A5 or other event included in Table 2 above. For example, referring to FIG. 5, the UE 504 may, at 518, detect an event triggering a measurement report based on performing the beam measurements at 514 and, in some aspects, generating the one or more predictions at 516.

At 810, the UE may transmit, for a first network device, a set of predictions related to at least one potential handover operation with at least one candidate cell in the plurality of candidate cells based on the set of measurements performed by the UE and associated with the UE mobility. In some aspects, the UE may, at 812, transmit, for the first network device, a subset of the set of measurements. For example, 810 and 812 may be performed by application processor(s) 1806, cellular baseband processor(s) 1824, transceiver(s) 1822, antenna(s) 1880, and/or HO/PSCell update success prediction component 198 of FIG. 18. Transmitting the set of predictions, in some aspects, may include transmitting the set of predictions based on the detected handover related event. The subset of the set of measurement (e.g., all or some of the measurements in the set of measurements), in some aspects, may include measurements associated with the detected handover related event or the transmitted set of predictions. The UE, in some aspects, may transmit the set of predictions and/or the subset of the set of measurements in a measurement report. For example, referring to FIG. 5, the UE 504 may transmit a message 520 including the set of predictions generated at 516 and, in some aspects, including a subset of the measurements based on performing the beam measurements at 514.

At 814, the UE may perform a handover operation based on the set of predictions. For example, 814 may be performed by application processor(s) 1806, cellular baseband processor(s) 1824, transceiver(s) 1822, antenna(s) 1880, and/or HO/PSCell update success prediction component 198 of FIG. 18. For example, referring to FIG. 5, the UE 504 may perform a handover operation at 528. Aspects of performing the handover under different conditions are described in relation to FIGS. 9A, 9B, 10, and 11.

FIG. 9A is a flowchart 900 of a method of performing a handover operation based on the set of predictions at 814 of FIG. 8 in accordance with some aspects of the disclosure. The method may be performed by a UE (e.g., the UE 104, 504; the apparatus 1804). At 814A, the UE may perform a handover operation based on the set of predictions. Performing the handover operation at 814A, in some aspects, may include obtaining (or receiving), at 915, based on the set of predictions, updated information related to the plurality of candidate cells. For example, 814A and 915 may be performed by application processor(s) 1806, cellular baseband processor(s) 1824, transceiver(s) 1822, antenna(s) 1880, and/or HO/PSCell update success prediction component 198 of FIG. 18. In some aspects, the handover operation may be performed at 814A based on the updated information. The updated information, in some aspects, may include a revised candidate cell or cells for handover, e.g., in a RRC configuration message associated with a (non-conditional or regular) handover operation, CHO, LTM, or conditional LTM. For example, referring to FIG. 5, the UE 504 may, based on the indicated handover success rates included in the message 520, receive a revised indication of one or more candidate cells for handover (e.g., in an RRC configuration message of the one or more communications 530 associated with a HO operation, a CHO, an LTM, or a conditional LTM) and perform a handover operation at 528 based on the revised indication included in the one or more communications.

FIG. 9B is a flowchart 950 of a method of performing a handover operation based on the set of predictions at 814 of FIG. 8 in accordance with some aspects of the disclosure. The method may be performed by a UE (e.g., the UE 104, 504; the apparatus 1804). At 814B, the UE may perform a handover operation based on the set of predictions. Performing the handover operation at 814B, in some aspects, may include, at 916, obtaining (or receiving) a first indication to perform a first handover operation with a first candidate cell in the plurality of candidate cells. In some aspects, the first indication may be obtained (or received) before transmitting the set of predictions at 810. In some aspects, performing the handover operation at 814B may further include, at 917, obtaining (or receiving), based on a prediction in the set of predictions of a probability of a failure of the first handover operation that is above a threshold probability, a second indication to cancel the first handover operation, and, at 918, obtaining (or receiving), based on the set of predictions, a third indication to perform the handover operation with a second candidate cell in the plurality of candidate cells. For example, 814B and 916-918 may be performed by application processor(s) 1806, cellular baseband processor(s) 1824, transceiver(s) 1822, antenna(s) 1880, and/or HO/PSCell update success prediction component 198 of FIG. 18. In some aspects, the handover operation may be performed at 814B based on the third indication. The third indication, in some aspects, may include a revised candidate cell or cells for handover, e.g., in a RRC configuration message associated with a (non-conditional or regular) handover operation, CHO, LTM, or conditional LTM. For example, referring to FIG. 5, the UE 504 may, receive the configuration information 508 indicating a first candidate cell for a handover operation, and based on the indicated handover success rates included in the message 520, receive a revised indication of one or more candidate cells for handover (e.g., in an RRC configuration message of the one or more communications 530 associated with a HO operation, a CHO, an LTM, or a conditional LTM) and perform a handover operation at 528 based on the revised indication included in the one or more communications 530.

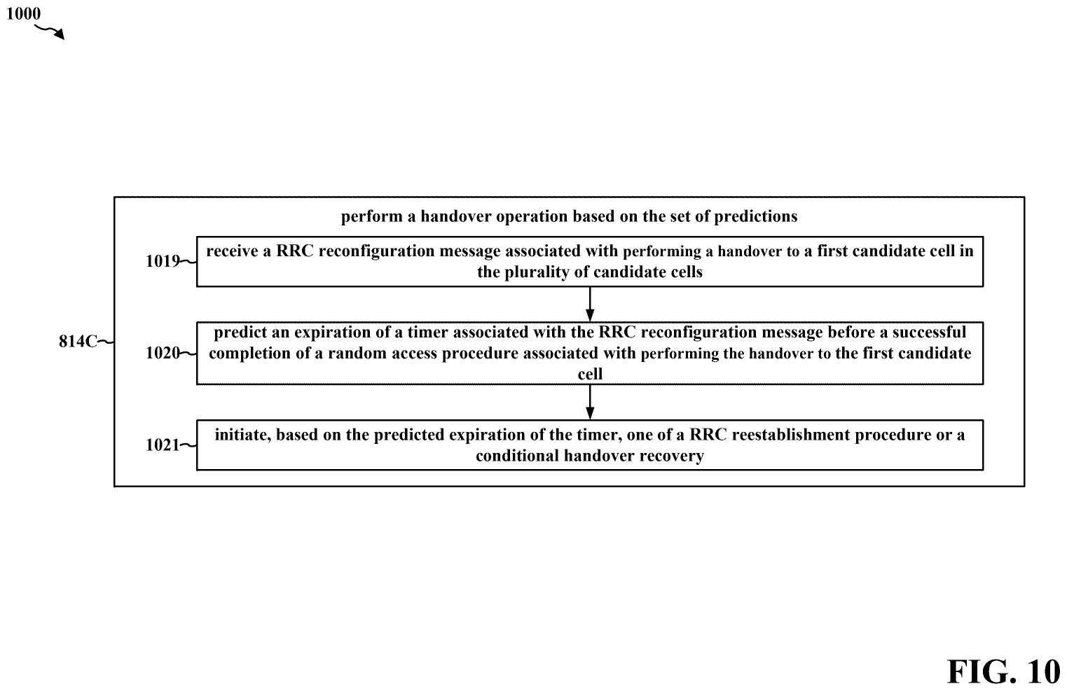

FIG. 10 is a flowchart 1000 of a method of performing a handover operation based on the set of predictions at 814 of FIG. 8 in accordance with some aspects of the disclosure. The method may be performed by a UE (e.g., the UE 104, 504; the apparatus 1804). At 814C, the UE may perform a handover operation based on the set of predictions. Performing the handover operation at 814C, in some aspects, may include, at 1019, receiving a RRC reconfiguration message associated with performing a handover to a first candidate cell in the plurality of candidate cells. In some aspects, performing the handover operation at 814C may further include, at 1020, predicting an expiration of a timer associated with the RRC reconfiguration message before a successful completion of a random access procedure associated with performing the handover to the first candidate cell, and, at 1021, initiating, based on the predicted expiration of the timer, one of a RRC reestablishment procedure or a conditional handover recovery. For example, 814C and 1019-1021 may be performed by application processor(s) 1806, cellular baseband processor(s) 1824, transceiver(s) 1822, antenna(s) 1880, and/or HO/PSCell update success prediction component 198 of FIG. 18. In some aspects, the conditional handover recovery may be performed with a configured CHO candidate cell. For example, referring to FIG. 5, the UE 504 may, receive the configuration information 508 indicating at least one candidate cell for a CHO operation, and based on a prediction that a timer associated with the handover operation for a particular candidate cell (e.g., a T304 timer associated with a RRC reconfiguration message such as RRCReconfiguration) is likely to expire (e.g., is predicted to expire with a probability that is above a threshold probability), stop the timer (e.g., the T304 time), and initiate RRC re-establishment (via a message in the one or more communications 530) and/or perform CHO recovery on a configured CHO candidate cell based on measurements (or predicted measurements) associated with the configured CHO candidate cell as part of performing the handover operation at 528.

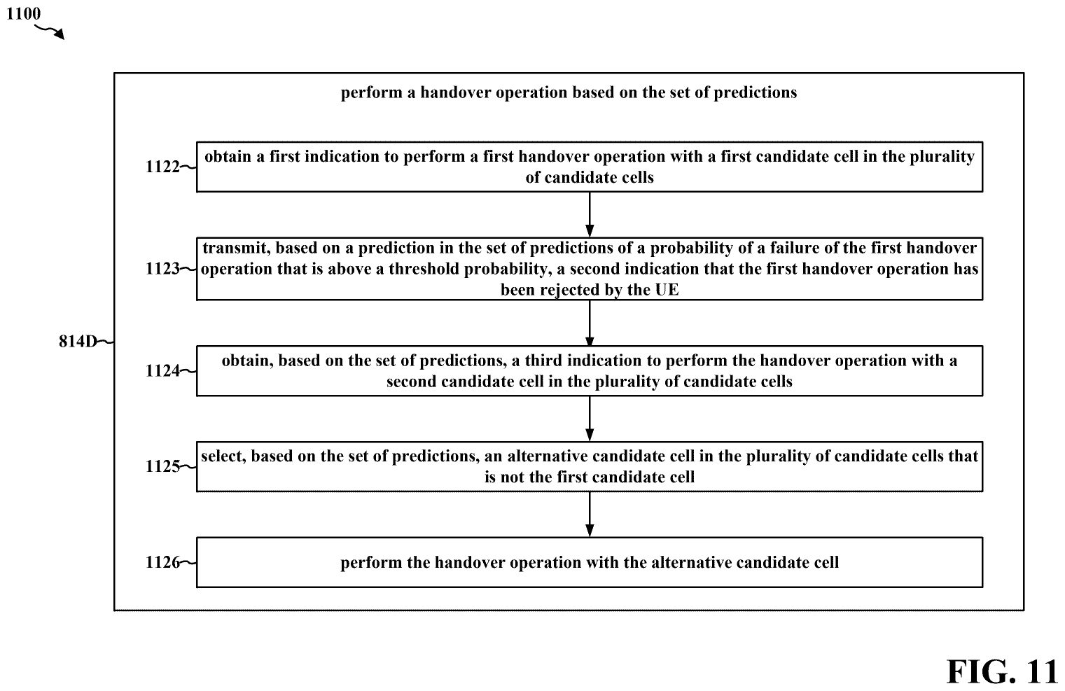

FIG. 11 is a flowchart 1100 of a method of performing a handover operation based on the set of predictions at 814 of FIG. 8 in accordance with some aspects of the disclosure. The method may be performed by a UE (e.g., the UE 104, 504; the apparatus 1804). At 814D, the UE may perform a handover operation based on the set of predictions. Performing the handover operation at 814D, in some aspects, may include, at 1122, obtaining a first indication to perform a first handover operation with a first candidate cell in the plurality of candidate cells and, at 1123, transmitting, based on a prediction in the set of predictions of a probability of a failure of the first handover operation that is above a threshold probability, a second indication that the first handover operation has been rejected by the UE. The second indication, in some aspects, may include (or be associated with) at least one of an additional set of measurements or a set of predicted measurements related to the rejected first handover operation or a cause value indicating a basis for the second indication. In some aspects, performing the handover operation at 814D may further include, at 1124, obtaining, based on the set of predictions, a third indication to perform the handover operation with a second candidate cell in the plurality of candidate cells, and, at 1125, selecting, based on the set of predictions, an alternative candidate cell in the plurality of candidate cells that is not the first candidate cell. In some aspects, performing the handover operation at 814D may further include, at 1126, performing the handover operation with the alternative candidate cell. For example, 814D and 1122-1126 may be performed by application processor(s) 1806, cellular baseband processor(s) 1824, transceiver(s) 1822, antenna(s) 1880, and/or HO/PSCell update success prediction component 198 of FIG. 18. In some aspects, the alternative candidate cell may be associated with a predicted probability of a successful handover operation that is above an additional threshold probability. For example, referring to FIG. 5, the UE 504 may, based upon its predictions of a handover failure to one or more candidate cells, e.g., if the handover failure probability is greater than a threshold probability, the UE 504 may “reject” a handover command, i.e., not perform handover to the candidate cell. If a handover command is rejected, the UE 504 may, in some aspects, transmit an indication (e.g., a message or a report included in the one or more communications 530) to the base station 502 that the UE 504 will not perform the handover and/or a cause value (e.g., a value indicating a reason for rejecting the handover with an indicated cell), and may provide related measurement reports. If configured with CHO, LTM, or conditional LTM candidate cells, the UE 504 may perform a handover to another candidate cell (e.g., a handover operation associated with the other candidate cell) as part of performing the handover operation at 528.

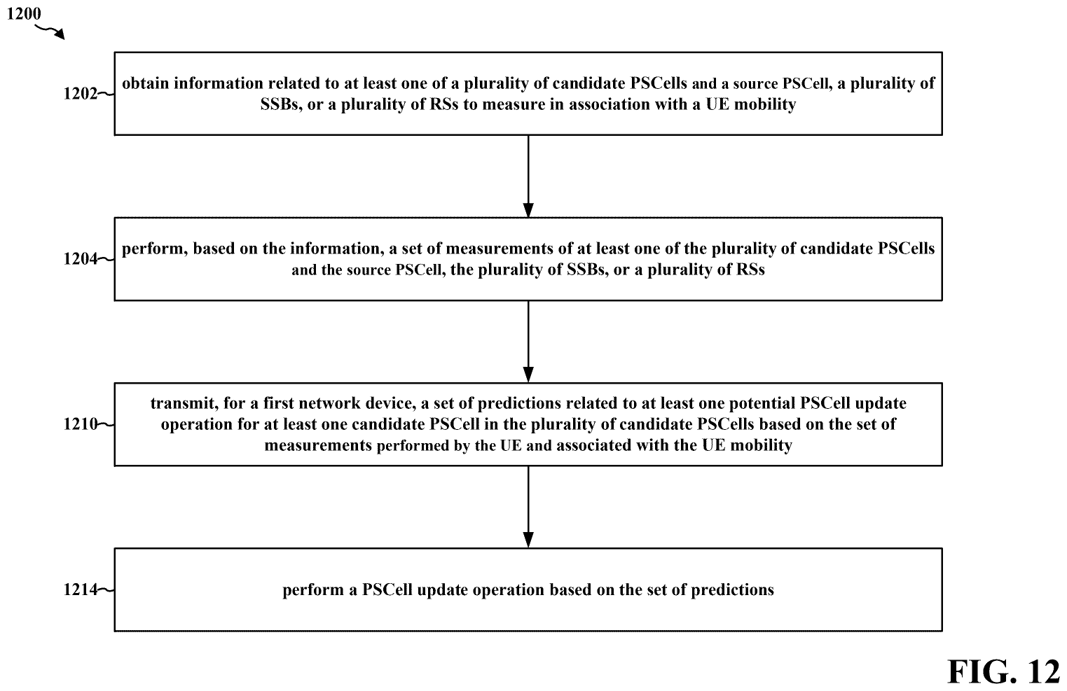

FIG. 12 is a flowchart 1200 of a method of wireless communication. The method may be performed by a UE (e.g., the UE 104, 604; the apparatus 1804). At 1202, the UE may obtain (or receive) information related to at least one of a plurality of candidate PSCells, a plurality of SSBs, or a plurality of RSs to measure in association with a UE mobility. For example, 1202 may be performed by application processor(s) 1806, cellular baseband processor(s) 1824, transceiver(s) 1822, antenna(s) 1880, and/or HO/PSCell update success prediction component 198 of FIG. 18. In some aspects, the information may be related to a plurality of SSSs to measure in association with the UE mobility. For example, referring to FIG. 6, the UE 604 may receive, configuration information 608 as part of obtaining configuration information at 610.

At 1204, the UE may measure (or obtain, based on the information, a set of measurements of) at least one of the plurality of candidate PSCells, the plurality of SSBs, or a plurality of RSs. For example, 1204 may be performed by application processor(s) 1806, cellular baseband processor(s) 1824, transceiver(s) 1822, antenna(s) 1880, and/or HO/PSCell update success prediction component 198 of FIG. 18. In some aspects, to obtain the set of measurements, the UE may measure one or more of the plurality of candidate PSCells, the plurality of SSBs, or the plurality of RSs. To obtain the set of measurements, in some aspects, the UE may measure the plurality of SSSs. For example, referring to FIG. 6, the UE 604 may perform, at 614 beam measurements for, on, or related to, a set of transmissions 612 from the base station 602 and the set of candidate PSCells 606.

In some aspects, the UE may generate, using a MT network, a set of predictions based on the set of measurements. In some aspects, the set of measurements may be provided as inputs to the MT network, and the output of the MT network may be the set of predictions. The set of predictions, in some aspects, may include a first prediction of a probability of a failure of a particular PSCell addition and/or PSCell change operation associated with a particular candidate PSCell in the plurality of candidate PSCells. The set of predictions, in some aspects, may include at least one of: a set of beam measurement predictions for a source cell and the plurality of candidate PSCells, a set of cell measurement predictions for the source cell and the plurality of candidate PSCells, one or more predictions of measurement events related to mobility, and one or more additional predictions of a RLF associated with the source cell. For example, referring to FIG. 6, the UE 604 may generate, at 616, one or more predictions based on performing the beam measurements at 614 (e.g., the measurements of the set of transmissions 612) using an AI/ML model (e.g., a machine-trained model).

The UE, in some aspects, may detect, based on the set of measurements, a PSCell update related event. Detecting the PSCell update related event, in some aspects, may be based on at least one prediction in the set of predictions generated at 1206. In some aspects, the PSCell update (e.g., a PSCell addition and/or PSCell change) related event may be, e.g., one of A3 or A5 or other event included in Table 2 above. For example, referring to FIG. 6, the UE 604 may, at 618, detect an event triggering a measurement report based on performing the beam measurements at 614 and, in some aspects, generating the one or more predictions at 616.

At 1210, the UE may transmit, for a first network device, a set of predictions related to at least one potential PSCell update operation with at least one candidate PSCell in the plurality of candidate PSCells based on the set of measurements associated with the UE mobility. In some aspects, the UE may, at 1212, transmit, for the first network device, a subset of the set of measurements. For example, 1210 and 1212 may be performed by application processor(s) 1806, cellular baseband processor(s) 1824, transceiver(s) 1822, antenna(s) 1880, and/or HO/PSCell update success prediction component 198 of FIG. 18. Transmitting the set of predictions, in some aspects, may include transmitting the set of predictions based on the detected PSCell update (e.g., PSCell addition and/or PSCell change) related event. The subset of the set of measurement (e.g., all or some of the measurements in the set of measurements), in some aspects, may include measurements associated with the detected PSCell update related event or the transmitted set of predictions. The UE, in some aspects, may transmit the set of predictions and/or the subset of the set of measurements in a measurement report. For example, referring to FIG. 6, the UE 604 may transmit a message 620 including the set of predictions generated at 616 and, in some aspects, including a subset of the measurements based on performing the beam measurements at 614.

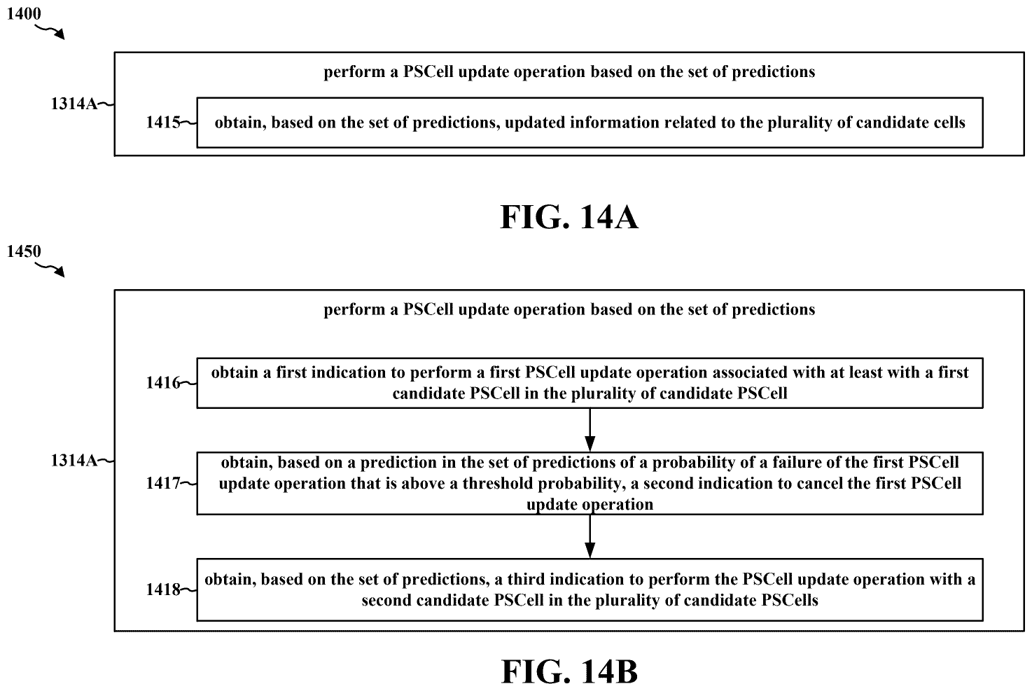

At 1214, the UE may perform a PSCell update operation based on the set of predictions. For example, 1214 may be performed by application processor(s) 1806, cellular baseband processor(s) 1824, transceiver(s) 1822, antenna(s) 1880, and/or HO/PSCell update success prediction component 198 of FIG. 18. For example, referring to FIG. 6, the UE 604 may perform a PSCell update operation at 628. Aspects of performing the PSCell update under different conditions are described in relation to FIGS. 14A, 14B, 15, and 16.

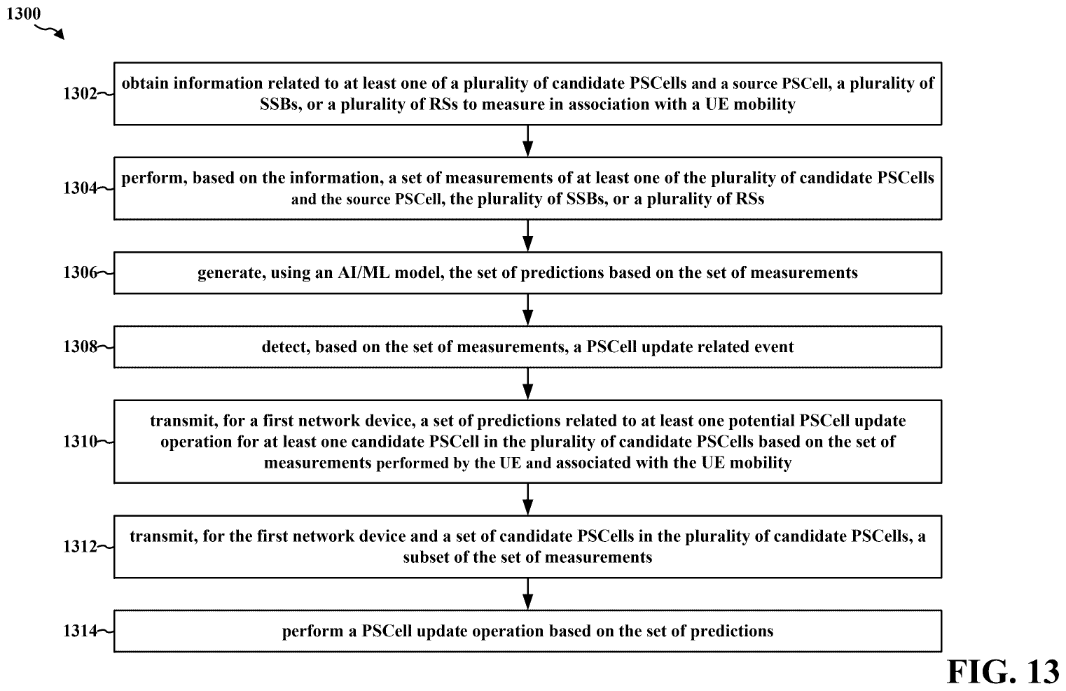

FIG. 13 is a flowchart 1300 of a method of wireless communication. The method may be performed by a UE (e.g., the UE 104, 604; the apparatus 1804). At 1302, the UE may obtain (or receive) information related to at least one of a plurality of candidate PSCells, a plurality of SSBs, or a plurality of RSs to measure in association with a UE mobility. For example, 1302 may be performed by application processor(s) 1806, cellular baseband processor(s) 1824, transceiver(s) 1822, antenna(s) 1880, and/or HO/PSCell update success prediction component 198 of FIG. 18. In some aspects, the information may be related to a plurality of SSSs to measure in association with the UE mobility. For example, referring to FIG. 6, the UE 604 may receive, configuration information 608 as part of obtaining configuration information at 610.

At 1304, the UE may measure (or obtain, based on the information, a set of measurements of) at least one of the plurality of candidate PSCells, the plurality of SSBs, or a plurality of RSs. For example, 1304 may be performed by application processor(s) 1806, cellular baseband processor(s) 1824, transceiver(s) 1822, antenna(s) 1880, and/or HO/PSCell update success prediction component 198 of FIG. 18. In some aspects, to obtain the set of measurements, the UE may measure one or more of the plurality of candidate PSCells, the plurality of SSBs, or the plurality of RSs. To obtain the set of measurements, in some aspects, the UE may measure the plurality of SSSs. For example, referring to FIG. 6, the UE 604 may perform, at 614 beam measurements for, on, or related to, a set of transmissions 612 from the base station 602 and the set of candidate PSCells 606.

At 1306, the UE may generate, using a MT network, a set of predictions based on the set of measurements. For example, 1306 may be performed by application processor(s) 1806, cellular baseband processor(s) 1824, transceiver(s) 1822, antenna(s) 1880, and/or HO/PSCell update success prediction component 198 of FIG. 18. In some aspects, the set of measurements may be provided as inputs to the MT network, and the output of the MT network may be the set of predictions. The set of predictions, in some aspects, may include a first prediction of a probability of a failure of a particular PSCell addition and/or PSCell change operation associated with a particular candidate PSCell in the plurality of candidate PSCells. The set of predictions, in some aspects, may include at least one of: a set of beam measurement predictions for a source cell and the plurality of candidate PSCells, a set of cell measurement predictions for the source cell and the plurality of candidate PSCells, one or more predictions of measurement events related to mobility, and one or more additional predictions of a RLF associated with the source cell. For example, referring to FIG. 6, the UE 604 may generate, at 616, one or more predictions based on performing the beam measurements at 614 (e.g., the measurements of the set of transmissions 612) using an AI/ML model (e.g., a machine-trained model).

At 1308, the UE may detect, based on the set of measurements, a PSCell update related event. For example, 1308 may be performed by application processor(s) 1806, cellular baseband processor(s) 1824, transceiver(s) 1822, antenna(s) 1880, and/or HO/PSCell update success prediction component 198 of FIG. 18. Detecting the PSCell update related event, in some aspects, may be based on at least one prediction in the set of predictions generated at 1306. In some aspects, the PSCell update (e.g., a PSCell addition and/or PSCell change) related event may be, e.g., one of A3 or A5 or other event included in Table 2 above. For example, referring to FIG. 6, the UE 604 may, at 618, detect an event triggering a measurement report based on performing the beam measurements at 614 and, in some aspects, generating the one or more predictions at 616.

At 1310, the UE may transmit, for a first network device, a set of predictions related to at least one potential PSCell update operation with at least one candidate PSCell in the plurality of candidate PSCells based on the set of measurements associated with the UE mobility. In some aspects, the UE may, at 1312, transmit, for the first network device, a subset of the set of measurements. For example, 1310 and 1312 may be performed by application processor(s) 1806, cellular baseband processor(s) 1824, transceiver(s) 1822, antenna(s) 1880, and/or HO/PSCell update success prediction component 198 of FIG. 18. Transmitting the set of predictions, in some aspects, may include transmitting the set of predictions based on the detected PSCell update (e.g., PSCell addition and/or PSCell change) related event. The subset of the set of measurement (e.g., all or some of the measurements in the set of measurements), in some aspects, may include measurements associated with the detected PSCell update related event or the transmitted set of predictions. The UE, in some aspects, may transmit the set of predictions and/or the subset of the set of measurements in a measurement report. For example, referring to FIG. 6, the UE 604 may transmit a message 620 including the set of predictions generated at 616 and, in some aspects, including a subset of the measurements based on performing the beam measurements at 614.

At 1314, the UE may perform a PSCell update operation based on the set of predictions. For example, 1314 may be performed by application processor(s) 1806, cellular baseband processor(s) 1824, transceiver(s) 1822, antenna(s) 1880, and/or HO/PSCell update success prediction component 198 of FIG. 18. For example, referring to FIG. 6, the UE 604 may perform a PSCell update operation at 628. Aspects of performing the PSCell update under different conditions are described in relation to FIGS. 14A, 14B, 15, and 16.

FIG. 14A is a flowchart 1400 of a method of performing a PSCell update operation based on the set of predictions at 1314 of FIG. 13 in accordance with some aspects of the disclosure. The method may be performed by a UE (e.g., the UE 104, 604; the apparatus 1804). At 1314A, the UE may perform a PSCell update operation based on the set of predictions. Performing the PSCell update operation at 1314A, in some aspects, may include obtaining (or receiving), at 1415, based on the set of predictions, updated information related to the plurality of candidate PSCells. For example, 1314A and 1415 may be performed by application processor(s) 1806, cellular baseband processor(s) 1824, transceiver(s) 1822, antenna(s) 1880, and/or HO/PSCell update success prediction component 198 of FIG. 18. In some aspects, the PSCell update operation may be performed at 1314A based on the updated information. The updated information, in some aspects, may include a revised candidate PSCell or cells for PSCell update, e.g., in a RRC configuration message associated with a (non-conditional or regular) PSCell addition and/or PSCell change operation, CPA, CPC, LTM, or conditional LTM. For example, referring to FIG. 6, the UE 604 may, based on the indicated PSCell addition and/or PSCell change success rates included in the message 620, receive a revised indication of one or more candidate PSCells for PSCell addition and/or PSCell change (e.g., in an RRC configuration message of the one or more communications 630 associated with a PSCell update operation, a CPA, CPC, an LTM, or a conditional LTM) and perform a PSCell update (e.g., a PSCell addition and/or PSCell change) operation at 628 based on the revised indication included in the one or more communications.

FIG. 14B is a flowchart 1450 of a method of performing a PSCell update operation based on the set of predictions at 1314 of FIG. 13 in accordance with some aspects of the disclosure. The method may be performed by a UE (e.g., the UE 104, 604; the apparatus 1804). At 1314B, the UE may perform a PSCell update operation based on the set of predictions. Performing the PSCell update operation at 1314B, in some aspects, may include, at 1416, obtaining (or receiving) first indication to perform a first PSCell update operation associated with at least with a first candidate PSCell in the plurality of candidate PSCells. In some aspects, the first indication may be obtained (or received) before transmitting the set of predictions at 1310. In some aspects, performing the PSCell update operation at 1314B may further include, at 1417, obtaining (or receiving), based on a prediction in the set of predictions of a probability of a failure of the first PSCell update operation that is above a threshold probability, a second indication to cancel the first PSCell update operation, and, at 1418, obtaining (or receiving), based on the set of predictions, a third indication to perform the PSCell update operation with a second candidate PSCell in the plurality of candidate PSCells. For example, 1314B and 1416-1418 may be performed by application processor(s) 1806, cellular baseband processor(s) 1824, transceiver(s) 1822, antenna(s) 1880, and/or HO/PSCell update success prediction component 198 of FIG. 18. In some aspects, the PSCell update operation may be performed at 1314B based on the third indication. The third indication, in some aspects, may include a revised candidate PSCell or cells for PSCell addition and/or PSCell change, e.g., in a RRC configuration message associated with a (non-conditional or regular) PSCell addition and/or PSCell change operation, CPA, CPC, LTM, or conditional LTM. For example, referring to FIG. 6, the UE 604 may, receive the configuration information 608 indicating a first candidate PSCell for a PSCell update (e.g., PSCell addition and/or PSCell change) operation, and based on the indicated PSCell update success rates included in the message 620, receive a revised indication of one or more candidate PSCells for a PSCell update (e.g., in an RRC configuration message of the one or more communications 630 associated with a PSCell update operation, a CPA, CPC, an LTM, or a conditional LTM) and perform a PSCell update operation at 628 based on the revised indication included in the one or more communications 630.

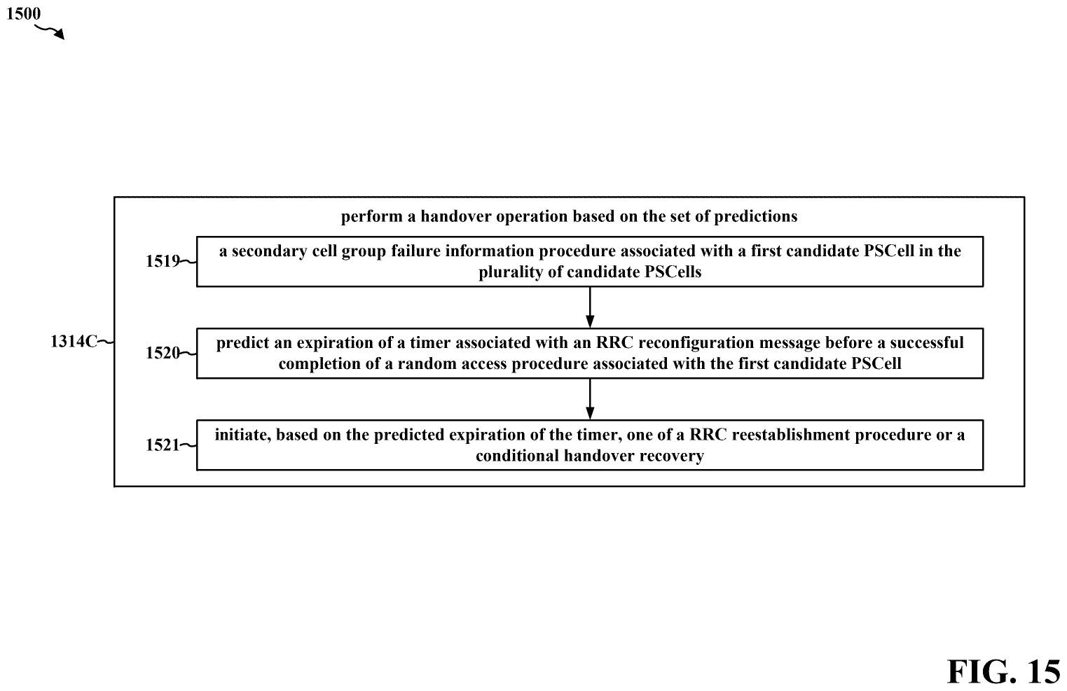

FIG. 15 is a flowchart 1500 of a method of performing a PSCell update operation based on the set of predictions at 1314 of FIG. 13 in accordance with some aspects of the disclosure. The method may be performed by a UE (e.g., the UE 104, 604; the apparatus 1804). At 1314C, the UE may perform a PSCell update operation based on the set of predictions. Performing the PSCell update operation at 1314C, in some aspects, may include, at 1519, performing a secondary cell group failure information procedure associated with (performing a PSCell update/addition for, or PSCell change to) a first candidate PSCell in the plurality of candidate PSCells. In some aspects, performing the PSCell update operation at 1314C may further include, at 1520, predicting an expiration of a timer associated with an RRC reconfiguration message before a successful completion of a random access procedure associated with (performing a PSCell update/addition for, or PSCell change to) the first candidate PSCell, and, at 1521, initiating, based on the predicted expiration of the timer, one of a RRC reestablishment procedure or a conditional PSCell update recovery. For example, 1314C and 1519-1521 may be performed by application processor(s) 1806, cellular baseband processor(s) 1824, transceiver(s) 1822, antenna(s) 1880, and/or HO/PSCell update success prediction component 198 of FIG. 18. In some aspects, the conditional PSCell update recovery may be performed with a configured CPA and/or CPC candidate PSCell. For example, referring to FIG. 6, the UE 604 may, receive the configuration information 608 indicating at least one candidate PSCell for a CPA and/or CPC operation, and based on a prediction that a timer associated with the PSCell update operation for a particular candidate PSCell (e.g., a T304 timer associated with a RRC reconfiguration message such as RRCReconfiguration) is likely to expire (e.g., is predicted to expire with a probability that is above a threshold probability), stop the timer (e.g., the T304 time), and initiate a SCG failure information procedure, initiate RRC re-establishment, and/or perform CPA and/or CPC recovery on a configured CPA and/or CPC candidate cell based on measurements (or predicted measurements) associated with the configured CPA and/or CPC candidate cell at 628.

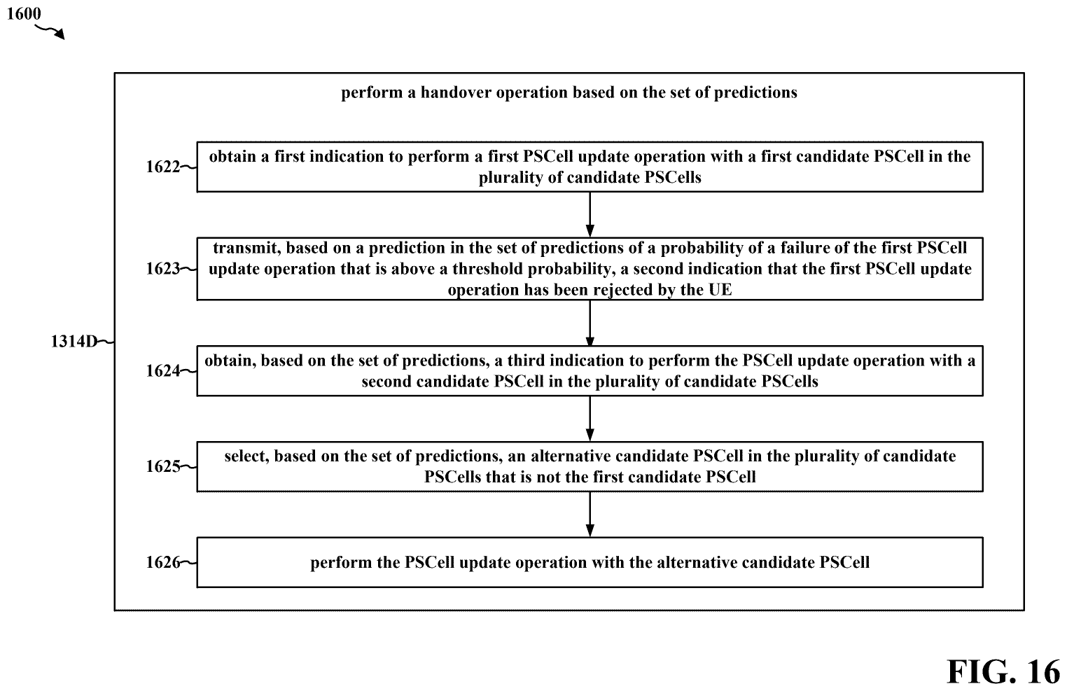

FIG. 16 is a flowchart 1600 of a method of performing a PSCell update operation based on the set of predictions at 1314 of FIG. 13 in accordance with some aspects of the disclosure. The method may be performed by a UE (e.g., the UE 104, 604; the apparatus 1804). At 1314D, the UE may perform a PSCell update operation based on the set of predictions. Performing the PSCell update operation at 1314D, in some aspects, may include, at 1622, obtaining a first indication to perform a first PSCell update operation with a first candidate PSCell in the plurality of candidate PSCells and, at 1623, transmitting, based on a prediction in the set of predictions of a probability of a failure of the first PSCell update operation that is above a threshold probability, a second indication that the first PSCell update operation has been rejected by the UE. The second indication, in some aspects, may include (or be associated with) at least one of an additional set of measurements related to the rejected first PSCell update operation or a cause value indicating a basis for the second indication. In some aspects, performing the PSCell update operation at 1314D may further include, at 1624, obtaining, based on the set of predictions, a third indication to perform the PSCell update operation with a second candidate PSCell in the plurality of candidate PSCells, and, at 1625, selecting, based on the set of predictions, an alternative candidate PSCell in the plurality of candidate PSCells that is not the first candidate PSCell, In some aspects, performing the PSCell update operation at 1314D may further include, at 1626, performing the PSCell update operation with the alternative candidate PSCell. For example, 1314D and 1622-1626 may be performed by application processor(s) 1806, cellular baseband processor(s) 1824, transceiver(s) 1822, antenna(s) 1880, and/or HO/PSCell update success prediction component 198 of FIG. 18. In some aspects, the alternative candidate PSCell may be associated with a predicted probability of a successful PSCell update operation that is above an additional threshold probability. For example, referring to FIG. 6, the UE 604 may, based upon its predictions of a PSCell update (e.g., PSCell addition and/or PSCell change) failure to one or more candidate PSCells, e.g., if the PSCell update failure probability is greater than a threshold probability, the UE 604 may “reject” a PSCell update command, i.e., not perform a PSCell update to the candidate PSCell. If a PSCell update command is rejected, the UE 604 may, in some aspects, transmit an indication (e.g., a message or a report included in the one or more communications 630) to the base station 602 that the UE 604 will not perform the PSCell update and/or a cause value (e.g., a value indicating a reason for rejecting the PSCell update with an indicated cell), and may provide related measurement reports. If configured with CPA, CPC, LTM, or conditional LTM candidate PSCells, the UE 604 may perform a PSCell update to another candidate PSCell (e.g., a PSCell addition and/or PSCell change operation associated with the other candidate PSCell) as part of performing the PSCell update operation at 628.

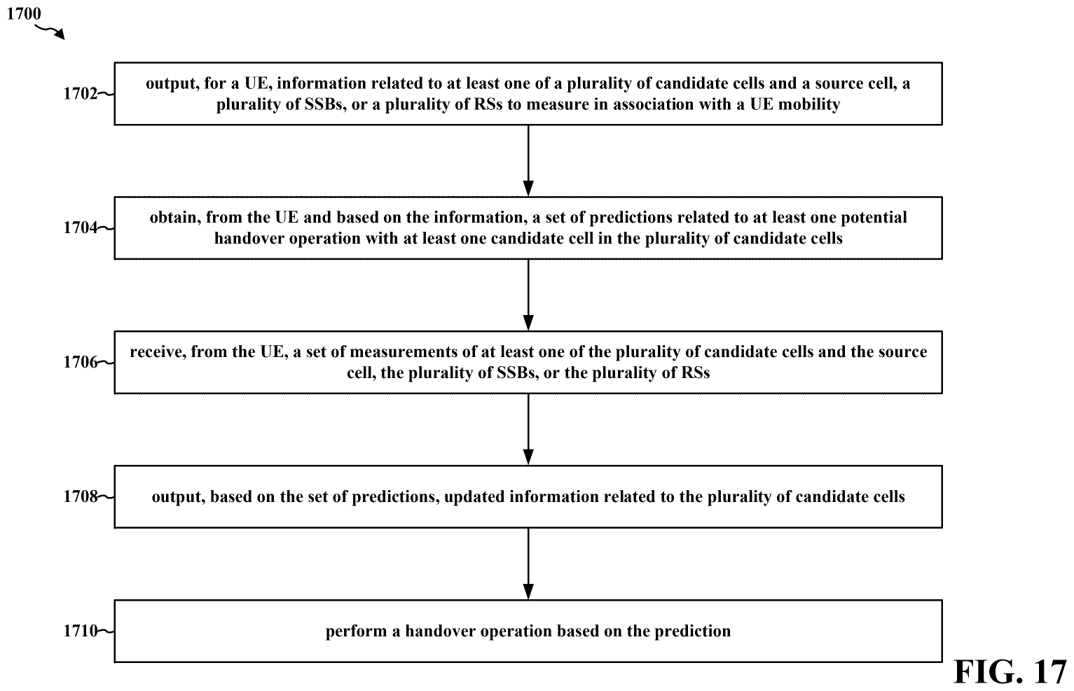

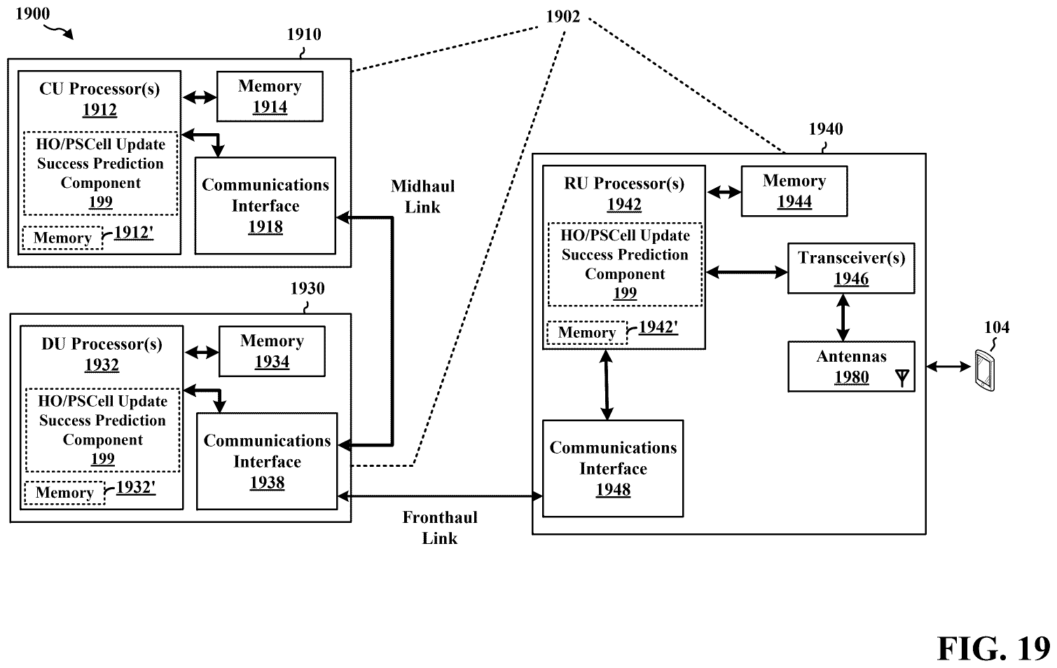

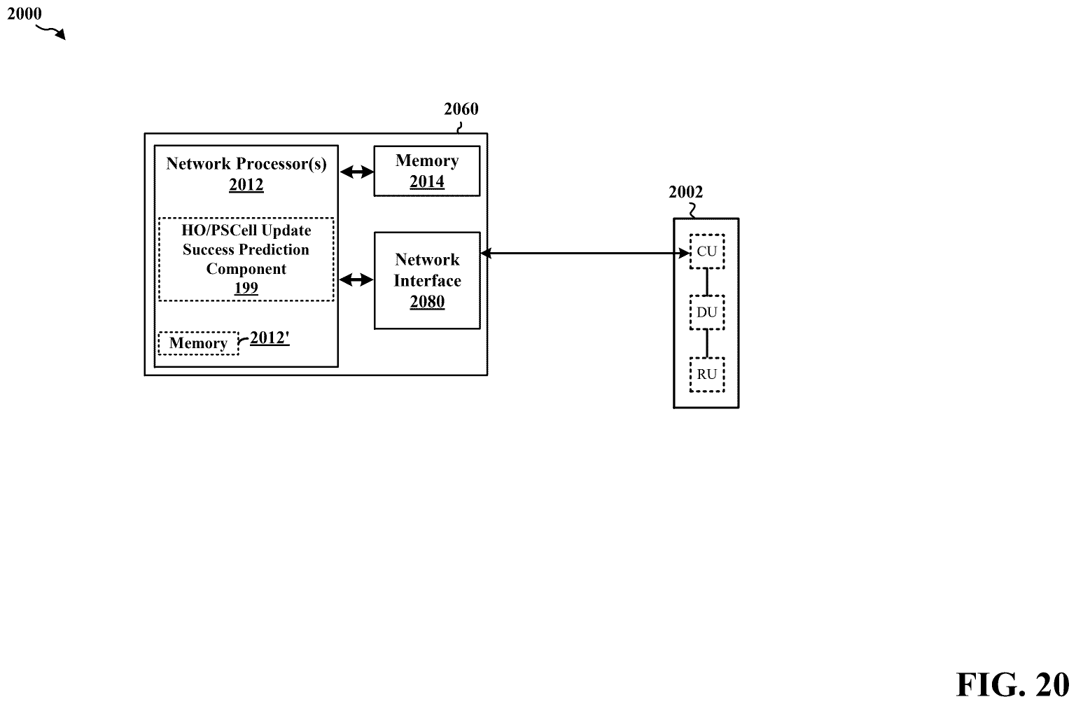

FIG. 17 is a flowchart 1700 of a method of wireless communication. The method may be performed by a base station (e.g., the base station 102, 502, 602; the network entity 1802, 1902, 2060). At 1702, the base station may transmit (or output), for a UE, information related to at least one of a plurality of candidate cells (or candidate PSCells) and a source cell (or a source PSCell), a plurality of SSBs, or a plurality of RSs to measure in association with a UE mobility. For example, 1702 may be performed by CU processor(s) 1912, DU processor(s) 1932, RU processor(s) 1942, transceiver(s) 1946, antenna(s) 1980, network processor 2012, network interface 2080, and/or HO/PSCell update success prediction component 199 of FIGS. 19 and 20. In some aspects, the information may be related to a plurality of SSSs to measure in association with the UE mobility. For example, referring to FIGS. 5 and 6, the base station 502 (or the base station 602) may receive, the configuration information 508 (or the configuration information 608) as part of obtaining configuration information at 510 (or at 610).

At 1704, the base station may obtain (or receive), from the UE and based on the information, a set of predictions related to at least one potential handover (or PSCell update) operation with at least one candidate cell (or candidate PSCell) in the plurality of candidate cells (or candidate PSCells). For example, 1704 may be performed by CU processor(s) 1912, DU processor(s) 1932, RU processor(s) 1942, transceiver(s) 1946, antenna(s) 1980, network processor 2012, network interface 2080, and/or HO/PSCell update success prediction component 199 of FIGS. 19 and 20. In some aspects, the set of predictions may be generated using an artificial intelligence or machine learning (AI/ML) model (or MT network) based on measurements of at least one of the plurality of candidate cells (candidate PSCells), the plurality of SSBs, or the plurality of RSs. The set of predictions, in some aspects, may include a first prediction of a probability of a failure of a particular handover operation associated with a particular candidate cell in the plurality of candidate cells. The set of predictions, in some aspects, may include at least one of: a set of beam measurement predictions for a source cell and the plurality of candidate cells, a set of cell measurement predictions for the source cell and the plurality of candidate cells, one or more predictions of measurement events related to mobility, and one or more additional predictions of a RLF associated with the source cell. The set of predictions, in some aspects, may include a first prediction of a probability of a failure of a particular PSCell addition and/or PSCell change operation associated with a particular candidate PSCell in the plurality of candidate PSCells. The set of predictions, in some aspects, may include at least one of: a set of beam measurement predictions for a source cell and the plurality of candidate PSCells, a set of cell measurement predictions for the source cell and the plurality of candidate PSCells, one or more predictions of measurement events related to mobility, and one or more additional predictions of a RLF associated with the source cell. For example, referring to FIGS. 5 and 6, the base station 502 (or the base station 602) may receive message 520 (or message 620) including the set of predictions generated at 516 (or at 616) and/or the beam and/or cell measurements made at 514 (or at 614).

In some aspects, the base station may, at 1706, receive, from the UE, a set of measurements of at least one of the plurality of candidate cells (or candidate PSCells) and the source cell (or the source PSCell), the plurality of SSBs, or the plurality of RSs. For example, 1706 may be performed by CU processor(s) 1912, DU processor(s) 1932, RU processor(s) 1942, transceiver(s) 1946, antenna(s) 1980, network processor 2012, network interface 2080, and/or HO/PSCell update success prediction component 199 of FIGS. 19 and 20. Receiving the set of measurements (e.g., all or some of the measurements in the set of measurements), in some aspects, may include measurements associated with a handover event or a PSCell update event detected at the UE. The base station, in some aspects, may receive the set of predictions and/or the set of measurements in a measurement report. For example, referring to FIGS. 5 and 6, the base station 502 (or the base station 602) may receive a message 620 including the set of predictions generated by the UE 504 (or the UE 604) at 616 and, in some aspects, including a subset of the measurements based on the UE 504 (or the UE 604) performing the beam measurements at 614.

At 1708, the base station may transmit (or output), based on the set of predictions, updated information related to the plurality of candidate cells. For example, 1708 may be performed by CU processor(s) 1912, DU processor(s) 1932, RU processor(s) 1942, transceiver(s) 1946, antenna(s) 1980, network processor 2012, network interface 2080, and/or HO/PSCell update success prediction component 199 of FIGS. 19 and 20. The updated information, in some aspects, may include a revised candidate cell or cells for handover, e.g., in a RRC configuration message associated with a (non-conditional or regular) handover operation, CHO, LTM, or conditional LTM. The updated information, in some aspects, may include a revised candidate PSCell or cells for PSCell update, e.g., in a RRC configuration message associated with a (non-conditional or regular) PSCell addition and/or PSCell change operation, CPA, CPC, LTM, or conditional LTM. For example, referring to FIGS. 5 and 6, the base station 502 (or the base station 602) may, based on the indicated handover success rates (or the indicated PSCell addition and/or PSCell change success rates) included in the message 520 (or the message 620), transmit (or output) a revised indication of one or more candidate cells for handover (e.g., in an RRC configuration message of the one or more communications 530 associated with a HO operation, a CHO, an LTM, or a conditional LTM) and/or one or more candidate PSCells for a PSCell addition and/or PSCell change (e.g., in an RRC configuration message of the one or more communications 630 associated with a HO operation, a CPA, CPC, an LTM, or a conditional LTM).

At 1710, the base station may perform a handover (or PSCell update) operation based on the set of predictions. For example, 1710 may be performed by CU processor(s) 1912, DU processor(s) 1932, RU processor(s) 1942, transceiver(s) 1946, antenna(s) 1980, network processor 2012, network interface 2080, and/or HO/PSCell update success prediction component 199 of FIGS. 19 and 20. For example, referring to FIG. 5, the UE 504 may perform a handover operation at 528.

For example, the UE and the base station may perform a handover operation based on the set of predictions. Performing the handover operation at 1710, in some aspects, may include the base station transmitting, based on the set of predictions, updated information related to the plurality of candidate cells. In some aspects, the handover operation is performed based on the updated information. The updated information, in some aspects, may include a revised candidate cell or cells for handover, e.g., in a RRC configuration message associated with a (non-conditional or regular) handover operation, CHO, LTM, or conditional LTM. For example, referring to FIG. 5, the base station 502 may, based on the indicated handover success rates included in the message 520, transmit a revised indication of one or more candidate cells for handover (e.g., in an RRC configuration message of the one or more communications 530 associated with a HO operation, a CHO, an LTM, or a conditional LTM) and perform a handover operation at 528 based on the revised indication included in the one or more communications.

Performing the handover operation at 1710, in some aspects, may include transmitting a first indication to perform a first handover operation with a first candidate cell in the plurality of candidate cells. In some aspects, the first indication may be transmitted before receiving the set of predictions at 1704. In some aspects, performing the handover operation may further include transmitting, based on a prediction in the set of predictions of a probability of a failure of the first handover operation that is above a threshold probability, a second indication to cancel the first handover operation, and, transmitting, based on the set of predictions, a third indication to perform the handover operation with a second candidate cell in the plurality of candidate cells. In some aspects, the handover operation may be performed based on the third indication. The third indication, in some aspects, may include a revised candidate cell or cells for handover, e.g., in a RRC configuration message associated with a (non-conditional or regular) handover operation, CHO, LTM, or conditional LTM. For example, referring to FIG. 5, the base station 502 may, transmit the configuration information 508 indicating a first candidate cell for a handover operation, and based on the indicated handover success rates included in the message 520, transmit a revised indication of one or more candidate cells for handover (e.g., in an RRC configuration message of the one or more communications 530 associated with a HO operation, a CHO, an LTM, or a conditional LTM) and perform a handover operation at 528 based on the revised indication included in the one or more communications 530.

In some aspects, performing the handover operation at 1710, in some aspects, may include transmitting a RRC reconfiguration message associated with performing a handover to a first candidate cell in the plurality of candidate cells. In some aspects, performing the handover operation at 1710 may further include the UE predicting an expiration of a timer associated with the RRC reconfiguration message before a successful completion of a random access procedure associated with performing the handover to the first candidate cell, and where the base station based on the predicted expiration of the timer, performs, based on the predicted expiration of the timer associated with the RRC reconfiguration message before a successful completion of the random access procedure associated with performing the handover to the first candidate cell, one of a RRC reestablishment procedure or a conditional handover recovery. In some aspects, the conditional handover recovery may be performed with a configured CHO candidate cell. For example, referring to FIG. 5, the base station 502 may, transmit the configuration information 508 indicating a at least one candidate cell for a CHO operation, and based on a prediction that a timer associated with the handover operation for a particular candidate cell (e.g., a T304 timer associated with a RRC reconfiguration message such as RRCReconfiguration) is likely to expire (e.g., is predicted to expire with a probability that is above a threshold probability) receive an indication associated with initiating RRC re-establishment (via a message in the one or more communications 530) and/or perform CHO recovery on a configured CHO candidate cell based on measurements (or predicted measurements) associated with the configured CHO candidate cell as part of performing the handover operation at 528.

Performing the handover operation at 1710, in some aspects, may include transmitting a first indication to perform a first handover operation with a first candidate cell in the plurality of candidate cells and receiving, based on a prediction in the set of predictions of a probability of a failure of the first handover operation that is above a threshold probability, a second indication that the first handover operation has been rejected by the UE. The second indication, in some aspects, may include (or be associated with) at least one of an additional set of measurements related to the rejected first handover operation or a cause value indicating a basis for the second indication. In some aspects, performing the handover operation at 1710 may further include transmitting, based on the set of predictions, a third indication to perform the handover operation with a second candidate cell in the plurality of candidate cells, and the UE selecting, based on the set of predictions, an alternative candidate cell in the plurality of candidate cells that is not the first candidate cell. In some aspects, performing the handover operation at 1710 may further include performing the handover operation with the alternative candidate cell. In some aspects, the alternative candidate cell may be associated with a predicted probability of a successful handover operation that is above an additional threshold probability. For example, referring to FIG. 5, the base station 502 may, based upon a prediction (at the UE 504) of a handover failure to one or more candidate cells, e.g., if the handover failure probability is greater than a threshold probability, receive an indication (e.g., a message or a report included in the one or more communications 530) that the UE 504 will not perform the handover and/or a cause value (e.g., a value indicating a reason for rejecting the handover with an indicated cell), and the UE 504 may provide related measurement reports. If configured with CHO, LTM, or conditional LTM candidate cells, the base station 502 may perform a handover to another candidate cell (e.g., a handover operation associated with the other candidate cell) as part of performing the handover operation at 528.

For example, the UE and the base station may perform a PSCell update operation based on the set of predictions. Performing the PSCell update operation at 1710, in some aspects, may include the base station transmitting, based on the set of predictions, updated information related to the plurality of candidate PSCells. In some aspects, the PSCell update operation is performed based on the updated information. The updated information, in some aspects, may include a revised candidate PSCell or cells for PSCell update, e.g., in a RRC configuration message associated with a (non-conditional or regular) PSCell addition and/or PSCell change operation, CPA, CPC, LTM, or conditional LTM. For example, referring to FIG. 6, the base station 602 may, based on the indicated PSCell addition and/or PSCell change success rates included in the message 620, transmit a revised indication of one or more candidate PSCells for PSCell addition and/or PSCell change (e.g., in an RRC configuration message of the one or more communications 630 associated with a PSCell update, a CPA, CPC, an LTM, or a conditional LTM) and perform a PSCell update (e.g., a PSCell addition and/or PSCell change) operation at 628 based on the revised indication included in the one or more communications.

Performing the PSCell update operation at 1710, in some aspects, may include transmitting a first indication to perform a first PSCell update operation associated with at least with a first candidate PSCell in the plurality of candidate PSCells. In some aspects, the first indication may be transmitted before receiving the set of predictions at 1704. In some aspects, performing the PSCell update operation may further include transmitting, based on a prediction in the set of predictions of a probability of a failure of the first PSCell update operation that is above a threshold probability, a second indication to cancel the first PSCell update operation, and transmitting, based on the set of predictions, a third indication to perform the PSCell update operation with a second candidate PSCell in the plurality of candidate PSCells. In some aspects, the PSCell update operation may be performed based on the third indication. The third indication, in some aspects, may include a revised candidate PSCell or cells for PSCell addition and/or PSCell change, e.g., in a RRC configuration message associated with a (non-conditional or regular) PSCell addition and/or PSCell change operation, CPA, CPC, LTM, or conditional LTM. For example, referring to FIG. 6, the base station 602 may, transmit the configuration information 608 indicating a first candidate PSCell for a PSCell update (e.g., PSCell addition and/or PSCell change) operation, and based on the indicated PSCell update success rates included in the message 620, transmit a revised indication of one or more candidate PSCells for a PSCell update (e.g., in an RRC configuration message of the one or more communications 630 associated with a PSCell update operation, a CPA, CPC, an LTM, or a conditional LTM) and perform a PSCell update operation at 628 based on the revised indication included in the one or more communications 630.

In some aspects, performing the PSCell update operation at 1710, in some aspects, may include performing a secondary cell group failure information procedure associated with (performing a PSCell update/addition for, or PSCell change to) a first candidate PSCell in the plurality of candidate PSCells. In some aspects, performing the PSCell update operation at 1710 may further include the UE predicting an expiration of a timer associated with an RRC reconfiguration message before a successful completion of a random access procedure associated with (performing the PSCell update/addition for, or PSCell change to) the first candidate PSCell, where the base station based on the predicted expiration of the timer, performs, based on the predicted expiration of the timer associated with the RRC reconfiguration message before a successful completion of the random access procedure associated with (performing a PSCell update/addition for, or PSCell change to) the first candidate PSCell, one of a RRC reestablishment procedure or a conditional PSCell update recovery. In some aspects, the conditional PSCell update recovery may be performed with a configured CPA and/or CPC candidate PSCell. For example, referring to FIG. 6, the base station 602 may, transmit the configuration information 608 indicating at least one candidate PSCell for a CPA and/or CPC operation, and based on a prediction that a timer associated with the PSCell update operation for a particular candidate PSCell (e.g., a T304 timer associated with a RRC reconfiguration message such as RRCReconfiguration) is likely to expire (e.g., is predicted to expire with a probability that is above a threshold probability) receive an indication associated with initiating a SCG failure information procedure, initiating RRC re-establishment, and/or performing CPA and/or CPC recovery on a configured CPA and/or CPC candidate cell based on measurements (or predicted measurements) associated with the configured CPA and/or CPC candidate cell at 628.

Performing the PSCell update operation at 1710, in some aspects, may include transmitting a first indication to perform a first PSCell update operation with a first candidate PSCell in the plurality of candidate PSCells and receiving, based on a prediction in the set of predictions of a probability of a failure of the first PSCell update operation that is above a threshold probability, a second indication that the first PSCell update operation has been rejected by the UE. The second indication, in some aspects, may include (or be associated with) at least one of an additional set of measurements related to the rejected first PSCell update operation or a cause value indicating a basis for the second indication. In some aspects, performing the PSCell update operation at 1710 may further include transmitting, based on the set of predictions, a third indication to perform the PSCell update operation with a second candidate PSCell in the plurality of candidate PSCells, and the UE selecting, based on the set of predictions, an alternative candidate PSCell in the plurality of candidate PSCells that is not the first candidate PSCell, In some aspects, performing the PSCell update operation at 1710 may further include, performing the PSCell update operation with the alternative candidate PSCell. In some aspects, the alternative candidate PSCell may be associated with a predicted probability of a successful PSCell update operation that is above an additional threshold probability. For example, referring to FIG. 6, the base station 602 may, based upon a prediction (at the UE 604) of a PSCell update (e.g., PSCell addition and/or PSCell change) failure to one or more candidate PSCells, e.g., if the PSCell update failure probability is greater than a threshold probability, receive an indication (e.g., a message or a report included in the one or more communications 630) that the UE 604 will not perform the PSCell update and/or a cause value (e.g., a value indicating a reason for rejecting the PSCell update with an indicated cell), and the UE 604 may provide related measurement reports. If configured with CPA, CPC, LTM, or conditional LTM candidate PSCells, the base station 602 may perform a PSCell update to another candidate PSCell (e.g., a PSCell addition and/or PSCell change operation associated with the other candidate PSCell) as part of performing the PSCell update operation at 628.

FIG. 18 is a diagram 1800 illustrating an example of a hardware implementation for an apparatus 1804. The apparatus 1804 may be a UE, a component of a UE, or may implement UE functionality. In some aspects, the apparatus 1804 may include at least one cellular baseband processor 1824 (also referred to as a modem) coupled to one or more transceivers 1822 (e.g., cellular RF transceiver). The cellular baseband processor(s) 1824 may include at least one on-chip memory 1824′. In some aspects, the apparatus 1804 may further include one or more subscriber identity modules (SIM) cards 1820 and at least one application processor 1806 coupled to a secure digital (SD) card 1808 and a screen 1810. The application processor(s) 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize one or more antennas 1880 for communication. The cellular baseband processor(s) 1824 communicates through the transceiver(s) 1822 via the one or more antennas 1880 with the UE 104 and/or with an RU associated with a network entity 1802. The cellular baseband processor(s) 1824 and the application processor(s) 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor(s) 1824 and the application processor(s) 1806 are each responsible for general processing, including the execution of software stored on the computer-readable medium/memory. The software, when executed by the cellular baseband processor(s) 1824/application processor(s) 1806, causes the cellular baseband processor(s) 1824/application processor(s) 1806 to perform the various functions described supra. The computer-readable medium/memory may also be used for storing data that is manipulated by the cellular baseband processor(s) 1824/application processor(s) 1806 when executing software. The cellular baseband processor(s) 1824/application processor(s) 1806 may be a component of the UE 350 and may include the at least one memory 360 and/or at least one of the TX processor 368, the RX processor 356, and the controller/processor 359. In one configuration, the apparatus 1804 may be at least one processor chip (modem and/or application) and include just the cellular baseband processor(s) 1824 and/or the application processor(s) 1806, and in another configuration, the apparatus 1804 may be the entire UE (e.g., see UE 350 of FIG. 3) and include the additional modules of the apparatus 1804.

As discussed supra, the HO/PSCell update success prediction component 198 may be configured to configured to obtain information related to at least one of a plurality of candidate cells and a source cell, a plurality of SSBs, or a plurality of RSs to measure in association with a UE mobility, perform, based on the information, a set of measurements of at least one of the plurality of candidate cells and the source cell, the plurality of SSBs, or the plurality of RSs, transmit, for a first network device, a set of predictions related to at least one potential handover operation with at least one candidate cell in the plurality of candidate cells based on the set of measurements performed by the UE and associated with the UE mobility, and perform a handover operation based on the set of predictions. The HO/PSCell update success prediction component 198, in some aspects, may be configured to obtain information related to at least one of a plurality of candidate PSCells and a source PSCell, a plurality of SSBs, or a plurality of RSs to measure in association with a UE mobility, perform, based on the information, a set of measurements of at least one of the plurality of candidate PSCells and the source PSCell, the plurality of SSBs, or a plurality of RSs, transmit, for a first network device, a set of predictions related to at least one potential PSCell update operation for at least one candidate PSCell in the plurality of candidate PSCells based on the set of measurements performed by the UE and associated with the UE mobility, and perform a PSCell update operation based on the set of predictions. The HO/PSCell update success prediction component 198 may be within the cellular baseband processor(s) 1824, the application processor(s) 1806, or both the cellular baseband processor(s) 1824 and the application processor(s) 1806. The HO/PSCell update success prediction component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1804 may include a variety of components configured for various functions. In one configuration, the apparatus 1804, and in particular the cellular baseband processor(s) 1824 and/or the application processor(s) 1806, may include means for obtaining information related to at least one of a plurality of candidate cells and a source cell, a plurality of synchronization signal blocks (SSBs), or a plurality of reference signals (RSs) to measure in association with a UE mobility. The apparatus 1804, and in particular the cellular baseband processor(s) 1824 and/or the application processor(s) 1806, may include means for performing, based on the information, a set of measurements of at least one of the plurality of candidate cells and the source cell, the plurality of SSBs, or the plurality of RSs. The apparatus 1804, and in particular the cellular baseband processor(s) 1824 and/or the application processor(s) 1806, may include means for transmitting, for a first network device, a set of predictions related to at least one potential handover operation with at least one candidate cell in the plurality of candidate cells based on the set of measurements performed by the UE and associated with the UE mobility. The apparatus 1804, and in particular the cellular baseband processor(s) 1824 and/or the application processor(s) 1806, may include means for performing a handover operation based on the set of predictions. The apparatus 1804, and in particular the cellular baseband processor(s) 1824 and/or the application processor(s) 1806, may include means for generating, using an AI/ML model, the set of predictions based on the set of measurements. The apparatus 1804, and in particular the cellular baseband processor(s) 1824 and/or the application processor(s) 1806, may include means for transmitting, for the first network device, a subset of the set of measurements. The apparatus 1804, and in particular the cellular baseband processor(s) 1824 and/or the application processor(s) 1806, may include means for detecting, based on the set of measurements, a handover related event. The apparatus 1804, and in particular the cellular baseband processor(s) 1824 and/or the application processor(s) 1806, may include means for obtaining, based on the set of predictions, updated information related to the plurality of candidate cells. The apparatus 1804, and in particular the cellular baseband processor(s) 1824 and/or the application processor(s) 1806, may include means for obtaining a first indication to perform a first handover operation with a first candidate cell in the plurality of candidate cells. The apparatus 1804, and in particular the cellular baseband processor(s) 1824 and/or the application processor(s) 1806, may include means for obtaining, based on a prediction in the set of predictions of a probability of a failure of the first handover operation that is above a threshold probability, a second indication to cancel the first handover operation. The apparatus 1804, and in particular the cellular baseband processor(s) 1824 and/or the application processor(s) 1806, may include means for obtaining, based on the set of predictions, a third indication to perform the handover operation with a second candidate cell in the plurality of candidate cells. The apparatus 1804, and in particular the cellular baseband processor(s) 1824 and/or the application processor(s) 1806, may include means for obtaining a first indication to perform a first handover operation with a first candidate cell in the plurality of candidate cells. The apparatus 1804, and in particular the cellular baseband processor(s) 1824 and/or the application processor(s) 1806, may include means for transmitting, based on a prediction in the set of predictions of a probability of a failure of the first handover operation that is above a threshold probability, a second indication that the first handover operation has been rejected by the UE. The apparatus 1804, and in particular the cellular baseband processor(s) 1824 and/or the application processor(s) 1806, may include means for obtaining, based on the set of predictions, a third indication to perform the handover operation with a second candidate cell in the plurality of candidate cells. The apparatus 1804, and in particular the cellular baseband processor(s) 1824 and/or the application processor(s) 1806, may include means for selecting, based on the set of predictions, an alternative candidate cell in the plurality of candidate cells that is not the first candidate cell. The apparatus 1804, and in particular the cellular baseband processor(s) 1824 and/or the application processor(s) 1806, may include means for performing the handover operation with the alternative candidate cell. The apparatus 1804, and in particular the cellular baseband processor(s) 1824 and/or the application processor(s) 1806, may include means for receiving a radio resource control (RRC) reconfiguration message associated with performing a handover to a first candidate cell in the plurality of candidate cells. The apparatus 1804, and in particular the cellular baseband processor(s) 1824 and/or the application processor(s) 1806, may include means for predicting an expiration of a timer associated with the RRC reconfiguration message before a successful completion of a random access procedure associated with performing the handover to the first candidate cell. The apparatus 1804, and in particular the cellular baseband processor(s) 1824 and/or the application processor(s) 1806, may include means for initiating, based on the predicted expiration of the timer, one of a RRC reestablishment procedure or a conditional handover recovery. The apparatus 1804, and in particular the cellular baseband processor(s) 1824 and/or the application processor(s) 1806, may include means for obtaining information related to at least one of a plurality of candidate primary secondary cells (PSCells) and a source PSCell, a plurality of synchronization signal blocks (SSBs), or a plurality of reference signals (RSs) to measure in association with a UE mobility. The apparatus 1804, and in particular the cellular baseband processor(s) 1824 and/or the application processor(s) 1806, may include means for performing, based on the information, a set of measurements of at least one of the plurality of candidate PSCells and the source PSCell, the plurality of SSBs, or a plurality of RSs. The apparatus 1804, and in particular the cellular baseband processor(s) 1824 and/or the application processor(s) 1806, may include means for transmitting, for a first network device, a set of predictions related to at least one potential PSCell update operation for at least one candidate PSCell in the plurality of candidate PSCells based on the set of measurements performed by the UE and associated with the UE mobility. The apparatus 1804, and in particular the cellular baseband processor(s) 1824 and/or the application processor(s) 1806, may include means for performing a PSCell update operation based on the set of predictions. The apparatus 1804, and in particular the cellular baseband processor(s) 1824 and/or the application processor(s) 1806, may include means for generating, using an AI/ML model, the set of predictions based on the set of measurements. The apparatus 1804, and in particular the cellular baseband processor(s) 1824 and/or the application processor(s) 1806, may include means for transmitting, for the first network device and a set of candidate PSCells in the plurality of candidate PSCells, a subset of the set of measurements. The apparatus 1804, and in particular the cellular baseband processor(s) 1824 and/or the application processor(s) 1806, may include means for detecting, based on the set of measurements, a PSCell update related event, where transmitting the set of predictions comprises transmitting the set of predictions based on the detected PSCell update related event. The apparatus 1804, and in particular the cellular baseband processor(s) 1824 and/or the application processor(s) 1806, may include means for obtaining a first indication to perform a first PSCell update operation associated with at least with a first candidate PSCell in the plurality of candidate PSCells. The apparatus 1804, and in particular the cellular baseband processor(s) 1824 and/or the application processor(s) 1806, may include means for obtaining, based on a prediction in the set of predictions of a probability of a failure of the first PSCell update operation that is above a threshold probability, a second indication to cancel the first PSCell update operation. The apparatus 1804, and in particular the cellular baseband processor(s) 1824 and/or the application processor(s) 1806, may include means for obtaining, based on the set of predictions, a third indication to perform the PSCell update operation with a second candidate PSCell in the plurality of candidate PSCells. The apparatus 1804, and in particular the cellular baseband processor(s) 1824 and/or the application processor(s) 1806, may include means for obtaining a first indication to perform a first PSCell update operation with a first candidate PSCell in the plurality of candidate PSCells. The apparatus 1804, and in particular the cellular baseband processor(s) 1824 and/or the application processor(s) 1806, may include means for transmitting, based on a prediction in the set of predictions of a probability of a failure of the first PSCell update operation that is above a threshold probability, a second indication that the first PSCell update operation has been rejected by the UE. The apparatus 1804, and in particular the cellular baseband processor(s) 1824 and/or the application processor(s) 1806, may include means for obtaining, based on the set of predictions, a third indication to perform the PSCell update operation with a second candidate PSCell in the plurality of candidate PSCells. The apparatus 1804, and in particular the cellular baseband processor(s) 1824 and/or the application processor(s) 1806, may include means for selecting, based on the set of predictions, an alternative candidate PSCell in the plurality of candidate PSCells that is not the first candidate PSCell. The apparatus 1804, and in particular the cellular baseband processor(s) 1824 and/or the application processor(s) 1806, may include means for performing the PSCell update operation with the alternative candidate PSCell. The apparatus 1804, and in particular the cellular baseband processor(s) 1824 and/or the application processor(s) 1806, may include means for performing a secondary cell group failure information procedure associated with a first candidate PSCell in the plurality of candidate PSCells. The apparatus 1804, and in particular the cellular baseband processor(s) 1824 and/or the application processor(s) 1806, may include means for predicting an expiration of a timer associated with an RRC reconfiguration message before a successful completion of a random access procedure associated with the first candidate PSCell. The apparatus 1804, and in particular the cellular baseband processor(s) 1824 and/or the application processor(s) 1806, may include means for initiating, based on the predicted expiration of the timer, one of a RRC reestablishment procedure or a conditional PSCell update recovery. The apparatus 1804, and in particular the cellular baseband processor(s) 1824 and/or the application processor(s) 1806, may include means for obtaining, based on the set of predictions, updated information related to the plurality of candidate PSCells, where performing the PSCell update operation is based on the updated information. The apparatus 1804 may further include means for performing any of the aspects described in connection with the flowcharts in FIGS. 7, 8, 9A, 9B, 10-13, 14A, 14B, 15, and 16, and/or performed by the UE in the communication flow of FIGS. 5 and 6. The means may be the HO/PSCell update success prediction component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the HO/PSCell update success prediction component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include at least one CU processor 1912. The CU processor(s) 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include at least one DU processor 1932. The DU processor(s) 1932 may include on-chip memory 1932′. In some aspects, the DU 1930 may further include additional memory modules 1934 and a communications interface 1938. The DU 1930 communicates with the RU 1940 through a fronthaul link. The RU 1940 may include at least one RU processor 1942. The RU processor(s) 1942 may include on-chip memory 1942′. In some aspects, the RU 1940 may further include additional memory modules 1944, one or more transceivers 1946, one or more antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the HO/PSCell update success prediction component 199 may be configured to transmit, for a UE, information related to at least one of a plurality of candidate cells and a source cell, a plurality of SSBs, or a plurality of RSs to measure in association with a UE mobility; obtain, from the UE and based on the information, a set of predictions related to at least one potential handover operation with at least one candidate cell in the plurality of candidate cells, and perform a handover operation based on the prediction. The HO/PSCell update success prediction component 199 may be configured to transmit, for a UE, information related to at least one of a plurality of candidate PSCells and a source PSCell, a plurality of SSBs, or a plurality of RSs to measure in association with a UE mobility; obtaining, from the UE and based on the information, a set of predictions related to at least one potential PSCell update operation with at least one candidate PSCell in the plurality of candidate PSCells; and performing a PSCell update operation based on the prediction. The HO/PSCell update success prediction component 199 may be within one or more processors of one or more of the CU 1910, DU 1930, and the RU 1940. The HO/PSCell update success prediction component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1902 may include a variety of components configured for various functions. In one configuration, the network entity 1902 may include means for transmitting, for a user equipment (UE), information related to at least one of a plurality of candidate cells and a source cell, a plurality of synchronization signal blocks (SSBs), or a plurality of reference signals (RSs) to measure in association with a UE mobility. The network entity 1902 may include means for obtaining, from the UE and based on the information, a set of predictions related to at least one potential handover operation with at least one candidate cell in the plurality of candidate cells. The network entity 1902 may include means for performing a handover operation based on the prediction. The network entity 1902 may include means for receiving, from the UE, a set of measurements of at least one of the plurality of candidate cells and the source cell, the plurality of SSBs, or the plurality of RSs. The network entity 1902 may include means for transmitting, based on the set of predictions, updated information related to the plurality of candidate cells. The network entity 1902 may include means for transmitting a first indication to perform a first handover operation with a first candidate cell in the plurality of candidate cells. The network entity 1902 may include means for transmitting, based on a prediction in the set of predictions of a probability of a failure of the first handover operation that is above a threshold probability, a second indication to cancel the first handover operation. The network entity 1902 may include means for transmitting, based on the set of predictions, a third indication to perform the handover operation with a second candidate cell in the plurality of candidate cells. The network entity 1902 may include means for transmitting a first indication to perform a first handover operation with a first candidate cell in the plurality of candidate cells. The network entity 1902 may include means for obtaining, based on a prediction in the set of predictions of a probability of a failure of the first handover operation that is above a threshold probability, a second indication that the first handover operation has been rejected by the UE. The network entity 1902 may include means for transmitting, based on the set of predictions, a third indication to perform the handover operation with a second candidate cell in the plurality of candidate cell. The network entity 1902 may include means for identifying, based on the set of predictions, an alternative candidate cell in the plurality of candidate cells that is not the first candidate cell, where the alternative candidate cell is associated with a predicted probability of a successful handover operation that is above an additional threshold probability. The network entity 1902 may include means for performing the handover operation with the alternative candidate cell. The network entity 1902 may include means for transmitting a radio resource control (RRC) reconfiguration message associated with performing a handover to a first candidate cell in the plurality of candidate cells. The network entity 1902 may include means for performing, based on a predicted expiration of a timer associated with the RRC reconfiguration message before a successful completion of a random access procedure associated with performing the handover to the first candidate cell, one of a RRC reestablishment procedure or a conditional handover recovery. The network entity 1902 may include means for transmitting, for a user equipment (UE), information related to at least one of a plurality of candidate PSCells and a source PSCell, a plurality of synchronization signal blocks (SSBs), or a plurality of reference signals (RSs) to measure in association with a UE mobility. The network entity 1902 may include means for obtaining, from the UE and based on the information, a set of predictions related to at least one potential PSCell update operation with at least one candidate PSCell in the plurality of candidate PSCells. The network entity 1902 may include means for performing a PSCell update operation based on the prediction. The network entity 1902 may include means for receiving, from the UE, a set of measurements of at least one of the plurality of candidate PSCells and the source PSCell, the plurality of SSBs, or the plurality of RSs. The network entity 1902 may include means for transmitting, based on the set of predictions, updated information related to the plurality of candidate PSCells. The network entity 1902 may include means for transmitting a first indication to perform a first PSCell update operation with a first candidate PSCell in the plurality of candidate PSCells. The network entity 1902 may include means for transmitting, based on a prediction in the set of predictions of a probability of a failure of the first PSCell update operation that is above a threshold probability, a second indication to cancel the first PSCell update operation. The network entity 1902 may include means for transmitting, based on the set of predictions, a third indication to perform the PSCell update operation with a second candidate PSCell in the plurality of candidate PSCells. The network entity 1902 may include means for transmitting a first indication to perform a first PSCell update operation with a first candidate PSCell in the plurality of candidate PSCells. The network entity 1902 may include means for obtaining, based on a prediction in the set of predictions of a probability of a failure of the first PSCell update operation that is above a threshold probability, a second indication that the first PSCell update operation has been rejected by the UE. The network entity 1902 may include means for transmitting, based on the set of predictions, a third indication to perform the PSCell update operation with a second candidate PSCell in the plurality of candidate PSCell. The network entity 1902 may include means for identifying, based on the set of predictions, an alternative candidate PSCell in the plurality of candidate PSCells that is not the first candidate PSCell, where the alternative candidate PSCell is associated with a predicted probability of a successful PSCell update operation that is above an additional threshold probability. The network entity 1902 may include means for performing the PSCell update operation with the alternative candidate PSCell. The network entity 1902 may include means for transmitting a radio resource control (RRC) reconfiguration message associated with a first candidate PSCell in the plurality of candidate PSCells. The network entity 1902 may include means for performing, based on a predicted expiration of a timer associated with the RRC reconfiguration message before a successful completion of a random access procedure associated with the first candidate PSCell, one of a RRC reestablishment procedure or a conditional PSCell update recovery. The network entity 1902 may further include means for performing any of the aspects described in connection with the flowcharts in FIG. 17, and/or performed by the base station in the communication flow of FIGS. 5 and 6. The means may be the HO/PSCell update success prediction component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIG. 17.

FIG. 20 is a diagram 2000 illustrating an example of a hardware implementation for a network entity 2060. In one example, the network entity 2060 may be within the core network 120. The network entity 2060 may include at least one network processor 2012. The network processor(s) 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002. The on-chip memory 2012′ and the additional memory modules 2014 may each be considered a computer-readable medium/memory. Each computer-readable medium/memory may be non-transitory. The network processor(s) 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the HO/PSCell update success prediction component 199 may be configured to transmit, for a UE, information related to at least one of a plurality of candidate cells and a source cell, a plurality of SSBs, or a plurality of RSs to measure in association with a UE mobility; obtain, from the UE and based on the information, a set of predictions related to at least one potential handover operation with at least one candidate cell in the plurality of candidate cells, and perform a handover operation based on the prediction. The HO/PSCell update success prediction component 199 may be configured to transmit, for a UE, information related to at least one of a plurality of candidate PSCells and a source PSCell, a plurality of SSBs, or a plurality of RSs to measure in association with a UE mobility; obtaining, from the UE and based on the information, a set of predictions related to at least one potential PSCell update operation with at least one candidate PSCell in the plurality of candidate PSCells; and performing a PSCell update operation based on the prediction. The HO/PSCell update success prediction component 199 may be within the network processor(s) 2012. The HO/PSCell update success prediction component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2060 may include a variety of components configured for various functions. In one configuration, the network entity 2060 may include means for transmitting, for a user equipment (UE), information related to at least one of a plurality of candidate cells and a source cell, a plurality of synchronization signal blocks (SSBs), or a plurality of reference signals (RSs) to measure in association with a UE mobility. The network entity 2060 may include means for obtaining, from the UE and based on the information, a set of predictions related to at least one potential handover operation with at least one candidate cell in the plurality of candidate cells. The network entity 2060 may include means for performing a handover operation based on the prediction. The network entity 2060 may include means for receiving, from the UE, a set of measurements of at least one of the plurality of candidate cells and the source cell, the plurality of SSBs, or the plurality of RSs. The network entity 2060 may include means for transmitting, based on the set of predictions, updated information related to the plurality of candidate cells. The network entity 2060 may include means for transmitting a first indication to perform a first handover operation with a first candidate cell in the plurality of candidate cells. The network entity 2060 may include means for transmitting, based on a prediction in the set of predictions of a probability of a failure of the first handover operation that is above a threshold probability, a second indication to cancel the first handover operation. The network entity 2060 may include means for transmitting, based on the set of predictions, a third indication to perform the handover operation with a second candidate cell in the plurality of candidate cells. The network entity 2060 may include means for transmitting a first indication to perform a first handover operation with a first candidate cell in the plurality of candidate cells. The network entity 2060 may include means for obtaining, based on a prediction in the set of predictions of a probability of a failure of the first handover operation that is above a threshold probability, a second indication that the first handover operation has been rejected by the UE. The network entity 2060 may include means for transmitting, based on the set of predictions, a third indication to perform the handover operation with a second candidate cell in the plurality of candidate cell. The network entity 2060 may include means for identifying, based on the set of predictions, an alternative candidate cell in the plurality of candidate cells that is not the first candidate cell, where the alternative candidate cell is associated with a predicted probability of a successful handover operation that is above an additional threshold probability. The network entity 2060 may include means for performing the handover operation with the alternative candidate cell. The network entity 2060 may include means for transmitting a radio resource control (RRC) reconfiguration message associated with performing a handover to a first candidate cell in the plurality of candidate cells. The network entity 2060 may include means for performing, based on a predicted expiration of a timer associated with the RRC reconfiguration message before a successful completion of a random access procedure associated with performing the handover to the first candidate cell, one of a RRC reestablishment procedure or a conditional handover recovery. The network entity 2060 may include means for transmitting, for a user equipment (UE), information related to at least one of a plurality of candidate PSCells and a source PSCell, a plurality of synchronization signal blocks (SSBs), or a plurality of reference signals (RSs) to measure in association with a UE mobility. The network entity 2060 may include means for obtaining, from the UE and based on the information, a set of predictions related to at least one potential PSCell update operation with at least one candidate PSCell in the plurality of candidate PSCells. The network entity 2060 may include means for performing a PSCell update operation based on the prediction. The network entity 2060 may include means for receiving, from the UE, a set of measurements of at least one of the plurality of candidate PSCells and the source PSCell, the plurality of SSBs, or the plurality of RSs. The network entity 2060 may include means for transmitting, based on the set of predictions, updated information related to the plurality of candidate PSCells. The network entity 2060 may include means for transmitting a first indication to perform a first PSCell update operation with a first candidate PSCell in the plurality of candidate PSCells. The network entity 2060 may include means for transmitting, based on a prediction in the set of predictions of a probability of a failure of the first PSCell update operation that is above a threshold probability, a second indication to cancel the first PSCell update operation. The network entity 2060 may include means for transmitting, based on the set of predictions, a third indication to perform the PSCell update operation with a second candidate PSCell in the plurality of candidate PSCells. The network entity 2060 may include means for transmitting a first indication to perform a first PSCell update operation with a first candidate PSCell in the plurality of candidate PSCells. The network entity 2060 may include means for obtaining, based on a prediction in the set of predictions of a probability of a failure of the first PSCell update operation that is above a threshold probability, a second indication that the first PSCell update operation has been rejected by the UE. The network entity 2060 may include means for transmitting, based on the set of predictions, a third indication to perform the PSCell update operation with a second candidate PSCell in the plurality of candidate PSCell. The network entity 2060 may include means for identifying, based on the set of predictions, an alternative candidate PSCell in the plurality of candidate PSCells that is not the first candidate PSCell, where the alternative candidate PSCell is associated with a predicted probability of a successful PSCell update operation that is above an additional threshold probability. The network entity 2060 may include means for performing the PSCell update operation with the alternative candidate PSCell. The network entity 2060 may include means for performing a secondary cell group failure information procedure associated with a first candidate PSCell in the plurality of candidate PSCells. The network entity 2060 may include means for performing, based on a predicted expiration of a timer associated with the RRC reconfiguration message before a successful completion of a random access procedure associated with the first candidate PSCell, one of a RRC reestablishment procedure or a conditional PSCell update recovery. The means may be the HO/PSCell update success prediction component 199 of the network entity 2060 configured to perform the functions recited by the means or as described in relation to FIGS. 5, 6, and 17.

Various aspects relate generally to a UE, via an AI/ML model, predicting a HO (or PSCell update) success probability (or HO failure rate) for specific target cells. The predicted HO success probability (or HO failure rate) for the specific target cells may be provided to a network (or network device) which can use the prediction for HO command decisions. For example, a UE may generate and provide predictions of the state of the communication environment (e.g., a probability of success and/or failure of a HO to one or more target cells) to improve aspects related to one or more of a HO operation, a PSCell change event, and/or a PSCell addition event. Some aspects more specifically relate to measuring transmissions from a set of candidate cells (which may alternatively be referred to as target cells and/or candidate target cells), generating a set of predictions regarding a success and/or failure rate associated with one or more of a HO failure, a PSCell change, or a PSCell addition for one or more candidate cells based on the measurements, providing one or more of the set of predictions to a network device, and performing at least one of the HO operation, the PSCell change, or the PSCell addition associated with the one or more candidate cells. In some examples, a UE may be configured to obtain information related to at least one of a plurality of candidate cells and a source cell, a plurality of SSBs, or a plurality of RSs to measure in association with a UE mobility, perform, based on the information, a set of measurements of at least one of the plurality of candidate cells and the source cell, the plurality of SSBs, or the plurality of RSs, transmit, for a first network device, a set of predictions related to at least one potential handover operation with at least one candidate cell in the plurality of candidate cells based on the set of measurements performed by the UE and associated with the UE mobility, and perform a handover operation based on the set of predictions. In some examples, a UE may be configured to obtain information related to at least one of a plurality of candidate PSCells and a source PSCell, a plurality of SSBs, or a plurality of RSs to measure in association with a UE mobility, perform, based on the information, a set of measurements of at least one of the plurality of candidate PSCells and the source PSCell, the plurality of SSBs, or a plurality of RSs, transmit, for a first network device, a set of predictions related to at least one potential PSCell update operation for at least one candidate PSCell in the plurality of candidate PSCells based on the set of measurements performed by the UE and associated with the UE mobility, and perform a PSCell update operation based on the set of predictions. In some examples, a network device may be configured to transmit, for a UE, information related to at least one of a plurality of candidate cells, a plurality of SSBs, or a plurality of RSs to measure in association with a UE mobility; obtain, from the UE and based on the information, a set of predictions related to at least one potential handover operation with at least one candidate cell in the plurality of candidate cells, and perform a handover operation based on the prediction. In some examples, a network device may be configured to transmit, for a UE, information related to at least one of a plurality of candidate PSCells and a source PSCell, a plurality of SSBs, or a plurality of RSs to measure in association with a UE mobility; obtaining, from the UE and based on the information, a set of predictions related to at least one potential PSCell update operation with at least one candidate PSCell in the plurality of candidate PSCells; and performing a PSCell update operation based on the prediction.

Particular aspects of the subject matter described in this disclosure can be implemented to realize one or more of the following potential advantages. In some examples, by generating a set of predictions regarding a communication environment and providing at least one of the predictions to a network device, the described techniques can be used to improve one or more of a HO operation, a PSCell change, or a PSCell addition.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: obtaining information related to at least one of a plurality of candidate cells and a source cell, a plurality of synchronization signal blocks (SSBs), or a plurality of reference signals (RSs) to measure in association with a UE mobility; performing, based on the information, a set of measurements of at least one of the plurality of candidate cells and the source cell, the plurality of SSBs, or the plurality of RSs; transmitting, for a first network device, a set of predictions related to at least one potential handover operation with at least one candidate cell in the plurality of candidate cells based on the set of measurements performed by the UE and associated with the UE mobility; and performing a handover operation based on the set of predictions.

Aspect 2 is the method of aspect 1, further comprising: generating, using an artificial intelligence or machine learning (AI/ML) model, the set of predictions based on the set of measurements.

Aspect 3 is the method of aspect 2, wherein the set of measurements is provided as inputs to the AI/ML model, and wherein an output of the AI/ML model is the set of predictions.

Aspect 4 is the method of any of aspects 1 to 3, wherein the set of predictions comprises a first prediction of a probability of a failure of a particular handover operation associated with a particular candidate cell in the plurality of candidate cells.

Aspect 5 is the method of any of aspects 1 to 4, wherein the set of predictions comprises at least one of: a set of beam measurement predictions for a source cell and the plurality of candidate cells; a set of cell measurement predictions for the source cell and the plurality of candidate cells; one or more predictions of measurement events related to mobility; and one or more additional predictions of a radio link failure associated with the source cell.

Aspect 6 is the method of aspect 5, further comprising: transmitting, for the first network device, a subset of the set of measurements.

Aspect 7 is the method of any of aspects 1 to 6, further comprising: detecting, based on the set of measurements, a handover related event, wherein transmitting the set of predictions comprises transmitting the set of predictions based on the detected handover related event.

Aspect 8 is the method of any of aspects 1 to 7, further performing the handover operation based on the set of predictions comprises: obtaining, based on the set of predictions, updated information related to the plurality of candidate cells, wherein the handover operation is based on the updated information.

Aspect 9 is the method of any of aspects 1 to 7, wherein performing the handover operation based on the set of predictions comprises: obtaining a first indication to perform a first handover operation with a first candidate cell in the plurality of candidate cells; obtaining, based on a prediction in the set of predictions of a probability of a failure of the first handover operation that is above a threshold probability, a second indication to cancel the first handover operation; and obtaining, based on the set of predictions, a third indication to perform the handover operation with a second candidate cell in the plurality of candidate cells.

Aspect 10 is the method of any of aspects 1 to 7, wherein performing the handover operation based on the set of predictions comprises: obtaining a first indication to perform a first handover operation with a first candidate cell in the plurality of candidate cells; transmitting, based on a prediction in the set of predictions of a probability of a failure of the first handover operation that is above a threshold probability, a second indication that the first handover operation has been rejected by the UE; and obtaining, based on the set of predictions, a third indication to perform the handover operation with a second candidate cell in the plurality of candidate cells.

Aspect 11 is the method of aspect 10, wherein the second indication further comprises at least one of an additional set of measurements or a set of predicted measurements related to the rejected first handover operation or a cause value indicating a basis for the second indication.

Aspect 12 is the method of any of aspects 10 and 11, wherein the plurality of candidate cells is associated with one or more of a conditional handover, a layer 1/layer 2 (L1/L2) triggered mobility (LTM), or a conditional LTM, and wherein performing the handover operation based on the set of predictions further comprises: selecting, based on the set of predictions, an alternative candidate cell in the plurality of candidate cells that is not the first candidate cell, wherein the alternative candidate cell is associated with a predicted probability of a successful handover operation that is above an additional threshold probability; and performing the handover operation with the alternative candidate cell.

Aspect 13 is the method of any of aspects 1 to 7, wherein performing the handover operation based on the set of predictions comprises: receiving a radio resource control (RRC) reconfiguration message associated with performing a handover to a first candidate cell in the plurality of candidate cells; predicting an expiration of a timer associated with the RRC reconfiguration message before a successful completion of a random access procedure associated with performing the handover to the first candidate cell; and initiating, based on the predicted expiration of the timer, one of a RRC reestablishment procedure or a conditional handover recovery.

Aspect 14 is a method of wireless communication at a user equipment (UE), comprising: obtaining information related to at least one of a plurality of candidate primary secondary cells (PSCells) and a source PSCell, a plurality of synchronization signal blocks (SSBs), or a plurality of reference signals (RSs) to measure in association with a UE mobility; performing, based on the information, a set of measurements of at least one of the plurality of candidate PSCells and the source PSCell, the plurality of SSBs, or a plurality of RSs; transmitting, for a first network device, a set of predictions related to at least one potential PSCell update operation for at least one candidate PSCell in the plurality of candidate PSCells based on the set of measurements performed by the UE and associated with the UE mobility; and performing a PSCell update operation based on the set of predictions.

Aspect 15 is the method of aspect 14, further comprising: generating, using an artificial intelligence or machine learning (AI/ML) model, the set of predictions based on the set of measurements.

Aspect 16 is the method of aspect 15, wherein the set of measurements is provided as inputs to the AI/ML model, and wherein an output of the AI/ML model is the set of predictions.

Aspect 17 is the method of any of aspects 14 to 16, wherein the set of predictions comprises a first prediction of a probability of a failure of a particular PSCell update operation associated with a particular candidate PSCell in the plurality of candidate PSCells.

Aspect 18 is the method of any of aspects 14 to 17, wherein the set of predictions comprises at least one of: a set of beam measurement predictions for the source PSCell and the plurality of candidate PSCells; a set of cell measurement predictions for the source PSCell and the plurality of candidate PSCells; one or more predictions of measurement events related to mobility; and one or more additional predictions of a radio link failure associated with the source PSCell.

Aspect 19 is the method of aspect 18, further comprising: transmitting, for the first network device and a set of candidate PSCells in the plurality of candidate PSCells, a subset of the set of measurements.

Aspect 20 is the method of any of aspects 14 to 19, further comprising: detecting, based on the set of measurements, a PSCell update related event, wherein transmitting the set of predictions comprises transmitting the set of predictions based on the detected PSCell update related event.

Aspect 21 is the method of any of aspects 14 to 20, wherein performing the PSCell update operation based on the predictions comprises: obtaining a first indication to perform a first PSCell update operation associated with at least with a first candidate PSCell in the plurality of candidate PSCells; obtaining, based on a prediction in the set of predictions of a probability of a failure of the first PSCell update operation that is above a threshold probability, a second indication to cancel the first PSCell update operation; and obtaining, based on the set of predictions, a third indication to perform the PSCell update operation with a second candidate PSCell in the plurality of candidate PSCells.

Aspect 22 is the method of any of aspects 14 to 21, wherein performing the PSCell update operation based on the set of predictions comprises: obtaining a first indication to perform a first PSCell update operation with a first candidate PSCell in the plurality of candidate PSCells; transmitting, based on a prediction in the set of predictions of a probability of a failure of the first PSCell update operation that is above a threshold probability, a second indication that the first PSCell update operation has been rejected by the UE; and obtaining, based on the set of predictions, a third indication to perform the PSCell update operation with a second candidate PSCell in the plurality of candidate PSCells.

Aspect 23 is the method of aspect 22, wherein the second indication further comprises at least one of an additional set of measurements or a set of predicted measurements related to the rejected first PSCell update operation or a cause value indicating a basis for the second indication.

Aspect 24 is the method of any of aspects 22 and 23, wherein the plurality of candidate PSCells is associated with one or more of a conditional PSCell change, a conditional PSCell addition, a layer 1/layer 2 (L1/L2) triggered mobility (LTM), or a conditional LTM, and performing the PSCell update operation based on the predictions further comprises: selecting, based on the set of predictions, an alternative candidate PSCell in the plurality of candidate PSCells that is not the first candidate PSCell, wherein the alternative candidate PSCell is associated with a predicted probability of a successful PSCell update operation that is above an additional threshold probability; and performing the PSCell update operation with the alternative candidate PSCell.

Aspect 25 is the method of any of aspects 14 to 21, wherein performing the PSCell update operation based on the set of predictions comprises: performing a secondary cell group failure information procedure associated with a first candidate PSCell in the plurality of candidate PSCells; predicting an expiration of a timer associated with an RRC reconfiguration message before a successful completion of a random access procedure associated with the first candidate PSCell; and initiating, based on the predicted expiration of the timer, one of a RRC reestablishment procedure or a conditional PSCell update recovery.

Aspect 26 is the method of any of aspects 14 to 21, further performing the PSCell update operation based on the set of predictions comprises: obtaining, based on the set of predictions, updated information related to the plurality of candidate PSCells, wherein the performing the PSCell update operation is based on the updated information.

Aspect 27 is a method of wireless communication at a network device, comprising: transmitting, for a user equipment (UE), information related to at least one of a plurality of candidate cells and a source cell, a plurality of synchronization signal blocks (SSBs), or a plurality of reference signals (RSs) to measure in association with a UE mobility; obtaining, from the UE and based on the information, a set of predictions related to at least one potential handover operation with at least one candidate cell in the plurality of candidate cells; and performing a handover operation based on the prediction.

Aspect 28 is the method of aspect 27, wherein the set of predictions is generated using an artificial intelligence or machine learning (AI/ML) model based on measurements of at least one of the plurality of candidate cells, the plurality of SSBs, or the plurality of RSs.

Aspect 29 is the method of aspect 28, wherein the set of measurements is provided as inputs to the AI/ML model, and wherein an output of the AI/ML model is the set of predictions.

Aspect 30 is the method of any of aspects 27 to 29, wherein the set of predictions comprises a first prediction of a probability of a failure of a particular handover operation associated with a particular candidate cell in the plurality of candidate cells.

Aspect 31 is the method of any of aspects 27 to 30, wherein the set of predictions comprises at least one of: a set of beam measurement predictions for a source cell and the plurality of candidate cells; a set of cell measurement predictions for the source cell and the plurality of candidate cells; one or more predictions of measurement events related to mobility; and one or more additional predictions of a radio link failure associated with the source cell.

Aspect 32 is the method of aspect 31, further comprising: receiving, from the UE, a set of measurements of at least one of the plurality of candidate cells, the plurality of SSBs, or the plurality of RSs.

Aspect 33 is the method of any of aspects 27 to 32, wherein obtaining the set of predictions comprises obtaining the set of predictions based on a handover related event detected at the UE.

Aspect 34 is the method of any of aspects 27 to 33, further comprising: transmitting, based on the set of predictions, updated information related to the plurality of candidate cells.

Aspect 35 is the method of any of aspects 27 to 33, wherein performing the handover operation based on the set of prediction comprises: transmitting a first indication to perform a first handover operation with a first candidate cell in the plurality of candidate cells; transmitting, based on a prediction in the set of predictions of a probability of a failure of the first handover operation that is above a threshold probability, a second indication to cancel the first handover operation; and transmitting, based on the set of predictions, a third indication to perform the handover operation with a second candidate cell in the plurality of candidate cells.

Aspect 36 is the method of any of aspects 27 to 33, wherein performing the handover operation based on the set of predictions comprises: transmitting a first indication to perform a first handover operation with a first candidate cell in the plurality of candidate cells; obtaining, based on a prediction in the set of predictions of a probability of a failure of the first handover operation that is above a threshold probability, a second indication that the first handover operation has been rejected by the UE; and transmitting, based on the set of predictions, a third indication to perform the handover operation with a second candidate cell in the plurality of candidate cells.

Aspect 37 is the method of aspect 36, wherein the second indication further comprises at least one of an additional set of measurements or a set of predicted measurements related to the rejected first handover operation or a cause value indicating a basis for the second indication.

Aspect 38 is the method of any of aspects 36 to 37, wherein the plurality of candidate cells is associated with one or more of a conditional handover, a layer 1/layer 2 (L1/L2) triggered mobility (LTM), or a conditional LTM, performing the handover operation based on the set of predictions further comprising: identifying, based on the set of predictions, an alternative candidate cell in the plurality of candidate cells that is not the first candidate cell, wherein the alternative candidate cell is associated with a predicted probability of a successful handover operation that is above an additional threshold probability; and performing the handover operation with the alternative candidate cell.

Aspect 39 is the method of any of aspects 27 to 33, wherein performing the handover operation based on the set of predictions comprises: transmitting a radio resource control (RRC) reconfiguration message associated with performing a handover to a first candidate cell in the plurality of candidate cells; and performing, based on a predicted expiration of a timer associated with the RRC reconfiguration message before a successful completion of a random access procedure associated with performing the handover to the first candidate cell, one of a RRC reestablishment procedure or a conditional handover recovery.

Aspect 40 is a method of wireless communication at a network device, comprising: transmitting, for a user equipment (UE), information related to at least one of a plurality of candidate PSCells and a source PSCell, a plurality of synchronization signal blocks (SSBs), or a plurality of reference signals (RSs) to measure in association with a UE mobility; obtaining, from the UE and based on the information, a set of predictions related to at least one potential PSCell update operation with at least one candidate PSCell in the plurality of candidate PSCells; and performing a PSCell update operation based on the prediction.

Aspect 41 is the method of aspect 40, wherein the set of predictions is generated using an artificial intelligence or machine learning (AI/ML) model on measurements of at least one of the plurality of candidate PSCells, the plurality of SSBs, or the plurality of RSs.

Aspect 42 is the method of aspect 41, wherein the set of measurements is provided as inputs to the AI/ML model, and wherein an output of the AI/ML model is the set of predictions.

Aspect 43 is the method of any of aspects 40 to 42, wherein the set of predictions comprises a first prediction of a probability of a failure of a particular PSCell update operation associated with a particular candidate PSCell in the plurality of candidate PSCells.

Aspect 44 is the method of any of aspects 40 to 43, wherein the set of predictions comprises at least one of: a set of beam measurement predictions for the source PSCell and the plurality of candidate PSCells; a set of cell measurement predictions for the source PSCell and the plurality of candidate PSCells; one or more predictions of measurement events related to mobility; and one or more additional predictions of a radio link failure associated with the source PSCell.

Aspect 45 is the method of aspect 44, further comprising: receiving, from the UE, a set of measurements of at least one of the plurality of candidate PSCells, the plurality of SSBs, or the plurality of RSs.

Aspect 46 is the method of any of aspects 40 to 45, wherein obtaining the set of predictions comprises obtaining the set of predictions based on a PSCell update related event detected at the UE.

Aspect 47 is the method of any of aspects 40 to 46, further comprising: transmitting, based on the set of predictions, updated information related to the plurality of candidate PSCells.

Aspect 48 is the method of any of aspects 40 to 46, wherein performing the PSCell update operation based on the set of prediction comprises: transmitting a first indication to perform a first PSCell update operation with a first candidate PSCell in the plurality of candidate PSCells; transmitting, based on a prediction in the set of predictions of a probability of a failure of the first PSCell update operation that is above a threshold probability, a second indication to cancel the first PSCell update operation; and transmitting, based on the set of predictions, a third indication to perform the PSCell update operation with a second candidate PSCell in the plurality of candidate PSCells.

Aspect 49 is the method of any of aspects 40 to 46, wherein performing the PSCell update operation based on the set of predictions comprises: transmitting a first indication to perform a first PSCell update operation with a first candidate PSCell in the plurality of candidate PSCells; obtaining, based on a prediction in the set of predictions of a probability of a failure of the first PSCell update operation that is above a threshold probability, a second indication that the first PSCell update operation has been rejected by the UE; and transmitting, based on the set of predictions, a third indication to perform the PSCell update operation with a second candidate PSCell in the plurality of candidate PSCells.

Aspect 50 is the method of aspect 49, wherein the second indication further comprises at least one of an additional set of measurements or a set of predicted measurements related to the rejected first PSCell update operation or a cause value indicating a basis for the second indication.

Aspect 51 is the method of any of aspects 49 and 50, wherein the plurality of candidate PSCells is associated with one or more of a conditional PSCell update, a layer 1/layer 2 (L1/L2) triggered mobility (LTM), or a conditional LTM, performing the PSCell update operation based on the set of predictions further comprising: identifying, based on the set of predictions, an alternative candidate PSCell in the plurality of candidate PSCells that is not the first candidate PSCell, wherein the alternative candidate PSCell is associated with a predicted probability of a successful PSCell update operation that is above an additional threshold probability; and performing the PSCell update operation with the alternative candidate PSCell.

Aspect 52 is the method of any of aspects 40 to 46, wherein performing the PSCell update operation based on the set of predictions comprises: performing a secondary cell group failure information procedure associated with a first candidate PSCell in the plurality of candidate PSCells; and performing, based on a predicted expiration of a timer associated with the RRC reconfiguration message before a successful completion of a random access procedure associated with the first candidate PSCell, one of a RRC reestablishment procedure or a conditional PSCell update recovery.

Aspect 53 is an apparatus for wireless communication at a device including a memory and at least one processor coupled to the memory and, based at least in part on information stored in the memory, the at least one processor is configured to implement any of aspects 1 to 26.

Aspect 54 is the apparatus of aspect 53, further including a transceiver or an antenna coupled to the at least one processor.

Aspect 55 is an apparatus for wireless communication at a device including means for implementing any of aspects 1 to 26.

Aspect 56 is a computer-readable medium (e.g., a non-transitory computer-readable medium) storing computer executable code, where the code when executed by a processor causes the processor to implement any of aspects 1 to 26.

Aspect 57 is an apparatus for wireless communication at a device including a memory and at least one processor coupled to the memory and, based at least in part on information stored in the memory, the at least one processor is configured to implement any of aspects 27 to 52.

Aspect 58 is the apparatus of aspect 57, further including a transceiver or an antenna coupled to the at least one processor.

Aspect 59 is an apparatus for wireless communication at a device including means for implementing any of aspects 27 to 52.

Aspect 60 is a computer-readable medium (e.g., a non-transitory computer-readable medium) storing computer executable code, where the code when executed by a processor causes the processor to implement any of aspects 27 to 52.

What is claimed is:

1. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
obtain information related to at least one of a plurality of candidate cells and a source cell, a plurality of synchronization signal blocks (SSBs), or a plurality of reference signals (RSs) to measure in association with a UE mobility;
perform, based on the information, a set of measurements of at least one of the plurality of candidate cells and the source cell, the plurality of SSBs, or the plurality of RSs;
transmit, for a first network device, a set of predictions related to at least one potential handover operation with at least one candidate cell in the plurality of candidate cells based on the set of measurements performed by the UE and associated with the UE mobility; and
perform a handover operation based on the set of predictions.

2. The apparatus of claim 1, wherein the at least one processor, individually or in any combination, is further configured to:
generate, using an artificial intelligence or machine learning (AI/ML) model, the set of predictions based on the set of measurements.

3. The apparatus of claim 2, wherein the set of measurements is provided as inputs to the AI/ML model, and wherein an output of the AI/ML model is the set of predictions.

4. The apparatus of claim 1, wherein the set of predictions comprises a first prediction of a probability of a failure of a particular handover operation associated with a particular candidate cell in the plurality of candidate cells.

5. The apparatus of claim 1, wherein the set of predictions comprises at least one of:
a set of beam measurement predictions for a source cell and the plurality of candidate cells;
a set of cell measurement predictions for the source cell and the plurality of candidate cells;
one or more predictions of measurement events related to mobility; and
one or more additional predictions of a radio link failure associated with the source cell.

6. The apparatus of claim 5, further comprising a transceiver coupled to the at least one processor, the transceiver being configured to:
transmit, for the first network device, a subset of the set of measurements.

7. The apparatus of claim 1, wherein the at least one processor, individually or in any combination, is further configured to:
detect, based on the set of measurements, a handover related event, wherein transmitting the set of predictions comprises transmitting the set of predictions based on the detected handover related event.

8. The apparatus of claim 1, wherein, to perform the handover operation based on the set of predictions, the at least one processor, individually or in any combination, is further configured to:
obtain, based on the set of predictions, updated information related to the plurality of candidate cells, wherein the handover operation is based on the updated information.

9. The apparatus of claim 1, wherein, to perform the handover operation based on the set of predictions, the at least one processor, individually or in any combination, is further configured to:
obtain a first indication to perform a first handover operation with a first candidate cell in the plurality of candidate cells;
obtain, based on a prediction in the set of predictions of a probability of a failure of the first handover operation that is above a threshold probability, a second indication to cancel the first handover operation; and
obtain, based on the set of predictions, a third indication to perform the handover operation with a second candidate cell in the plurality of candidate cells.

10. The apparatus of claim 1, wherein, to perform the handover operation based on the set of predictions, the at least one processor, individually or in any combination, is further configured to:
obtain a first indication to perform a first handover operation with a first candidate cell in the plurality of candidate cells;
transmit, based on a prediction in the set of predictions of a probability of a failure of the first handover operation that is above a threshold probability, a second indication that the first handover operation has been rejected by the UE; and
obtain, based on the set of predictions, a third indication to perform the handover operation with a second candidate cell in the plurality of candidate cells.

11. The apparatus of claim 10, wherein the second indication further comprises at least one of an additional set of measurements or a set of predicted measurements related to the rejected first handover operation or a cause value indicating a basis for the second indication.

12. The apparatus of claim 10, wherein the plurality of candidate cells is associated with one or more of a conditional handover, a layer 1/layer 2 (L1/L2) triggered mobility (LTM), or a conditional LTM, and wherein, to perform the handover operation based on the set of predictions, the at least one processor, individually or in any combination, is further configured to:
select, based on the set of predictions, an alternative candidate cell in the plurality of candidate cells that is not the first candidate cell, wherein the alternative candidate cell is associated with a predicted probability of a successful handover operation that is above an additional threshold probability; and
perform the handover operation with the alternative candidate cell.

13. The apparatus of claim 1, wherein, to perform the handover operation based on the set of predictions, the at least one processor, individually or in any combination, is further configured to:
receive a radio resource control (RRC) reconfiguration message associated with performing a handover to a first candidate cell in the plurality of candidate cells;
predict an expiration of a timer associated with the RRC reconfiguration message before a successful completion of a random access procedure associated with performing a handover to the first candidate cell; and
initiate, based on the predicted expiration of the timer, one of a RRC reestablishment procedure or a conditional handover recovery.

14. A method of wireless communication at a user equipment (UE), comprising:
obtaining information related to at least one of a plurality of candidate cells and a source cell, a plurality of synchronization signal blocks (SSBs), or a plurality of reference signals (RSs) to measure in association with a UE mobility;
performing, based on the information, a set of measurements of at least one of the plurality of candidate cells and the source cell, the plurality of SSBs, or the plurality of RSs;
transmitting, for a first network device, a set of predictions related to at least one potential handover operation with at least one candidate cell in the plurality of candidate cells based on the set of measurements performed by the UE and associated with the UE mobility; and
performing a handover operation based on the set of predictions.

15. An apparatus for wireless communication at a user equipment (UE), comprising:
at least one memory; and
at least one processor coupled to the at least one memory and, based at least in part on stored information that is stored in the at least one memory, the at least one processor, individually or in any combination, is configured to:
obtain information related to at least one of a plurality of candidate primary secondary cells (PSCells) and a source PSCell, a plurality of synchronization signal blocks (SSBs), or a plurality of reference signals (RSs) to measure in association with a UE mobility;
perform, based on the information, a set of measurements of at least one of the plurality of candidate PSCells and the source PSCell, the plurality of SSBs, or a plurality of RSs;
transmit, for a first network device, a set of predictions related to at least one potential PSCell update operation for at least one candidate PSCell in the plurality of candidate PSCells based on the set of measurements performed by the UE and associated with the UE mobility; and
perform a PSCell update operation based on the set of predictions.

16. The apparatus of claim 15, wherein the at least one processor, individually or in any combination, is further configured to:
generate, using an artificial intelligence or machine learning (AI/ML) model, the set of predictions based on the set of measurements, wherein the set of measurements is provided as inputs to the AI/ML model, and wherein an output of the AI/ML model is the set of predictions.

17. The apparatus of claim 15, wherein the set of predictions comprises a first prediction of a probability of a failure of a particular PSCell update operation associated with a particular candidate PSCell in the plurality of candidate PSCells.

18. The apparatus of claim 15, wherein the set of predictions comprises at least one of:
a set of beam measurement predictions for the source PSCell and the plurality of candidate PSCells;
a set of cell measurement predictions for the source PSCell and the plurality of candidate PSCells;
one or more predictions of measurement events related to mobility; and
one or more additional predictions of a radio link failure associated with the source PSCell.

19. The apparatus of claim 18, further comprising a transceiver coupled to the at least one processor, the transceiver being configured to:
transmit, for the first network device and a set of candidate PSCells in the plurality of candidate PSCells, a subset of the set of measurements.

20. The apparatus of claim 15, wherein, to perform the PSCell update operation based on the set of predictions, the at least one processor, individually or in any combination, is further configured to:
obtaining, based on the set of predictions, updated information related to the plurality of candidate PSCells, wherein the performing the PSCell update operation is based on the updated information.
